(19) United States
(12) Patent Application Publication
(10) Pub. No.: US 2014/0041433 A1
(43) Pub. Date: Feb. 13, 2014

(54) ROLLING TOOL ASSEMBLIES FOR CRANKSHAFT ROLLING MACHINES

(71) Applicant: Ingersoll CM Systems LLC, Midland, MI (US)

(72) Inventors: Marc D. St. Pierre, Midland, MI (US); Kenneth M. Goodin, Midland, MI (US)

(73) Assignee: Ingersoll CM Systems, Midland, MI (US)

(21) Appl. No.: 13/963,904

(22) Filed: Aug. 9, 2013

Related U.S. Application Data
(60) Provisional application No. 61/681,372, filed on Aug. 9, 2012.

(51) Int. Cl. F16C 9/02

(52) U.S. Cl. CPC F16C 9/02
USPC 72/252.5

(57) ABSTRACT

A rolling tool assembly is provided that has a generally three-piece housing construction including a main, generally C-shaped body or frame member and a pair of opposing side plate members, that are fastened together to close off the open sides of the generally C-shaped body member for forming an interior space into which the remaining components of the rolling tool assembly can be mounted. In one alternative, the body member is made to be of a standard size with the side plate members being custom-made so that the side plate members vary in predetermined dimensions thereof to correspond to the size of the crankshaft bearing to be rolled. In another alternative, the side plate members are made to be of standard size while the body member is custom-made to vary in predetermined dimensions thereof to correspond to the size of the crankshaft bearing to be rolled.

### CROSS REFERENCES TO RELATED APPLICATIONS

This application claims benefit under 35 U.S.C. §119 (e) to U.S. Provisional Application No. 61/681,372, entitled “Rolling Tool Assemblies for Crankshaft Rolling Machines” filed Aug. 9, 2012 having attorney docket number 7802-102222-U.S., the contents of which are incorporated herein by reference in its entirety.

### FIELD OF THE INVENTION

The invention relates to rolling tool assemblies for crankshaft rolling machines that perform deep rolling operations on crankshafts for increasing the fatigue strength thereof.

### BACKGROUND OF THE INVENTION

The principal of rolling crankshaft bearings in the annular fillet areas for increasing fatigue strength has been known for many years. Rolling of fillet radii increases bending fatigue strength by applying compressive residual stresses into the areas below the surface of the material being rolled. The crankshaft rolling operation is performed by rolling tools or rolling tool assemblies that include work rollers and support rollers that are brought into rolling engagement with the undercut fillet areas of main and pin bearings of crankshafts. Historically, a rolling tool assembly including the work rollers is mounted to one of a pair of opposed lever arms and the rolling tool assembly including the support rollers is mounted to the other one of the lever arms which are then actuated to bring the work and support rollers into engagement with the crankshaft for applying high rolling forces thereto. Alternatively, the rolling tool assemblies can be mounted on a single, common rolling arm such as described in commonly assigned U.S. Pat. No. 6,895,793, which is incorporated as if reproduced in this entirety herein.

Generally, the body or outer housing for the rolling tool assemblies consist of two symmetrical, opposite housing halves which are fastened together to form an interior space therebetween into which the interior components of the rolling tool assemblies are mounted. The size of these housing halves will vary depending on the size of the crankshaft bearing that is to be rolled. The bearing size varies in terms of its diameter and the width axially across the bearing between side walls or fences on either side thereof. So, for a particular range of smaller size crankshaft bearings, the housing halves are of a smaller size, whereas with larger size bearings, the housing halves are made to be larger so that the rollers can be appropriately sized and properly positioned with respect to the smaller or larger bearings to be rolled. Thus, with this approach, the rolling tool assemblies, and in particular the components for the outer housing thereof need to be custom made depending on the size of the crankshaft bearing to be rolled.

With respect to rolling tool assemblies for work rollers, the work rollers are a wear part since they are engaged with high forces against the crankshaft bearings undercut radii during rolling operations. Thus, the work rollers will periodically need to be replaced. Currently, replacement of the work rollers entails disassembly of multiple components individually including the roller retainer or cage members, and then the work rollers. Also, disassembly of the entire rolling tool assembly including removal of the cage members and opening of the housing is typically required for inspection of the back-up roller and its functional aspects. As is apparent, these can be labor intensive and time consuming procedures.

Similarly, the cage members also can bear against the work rollers along their end surfaces that support the work rollers in the rolling tool assemblies. Thus, when these roller support surfaces wear, the cage members need to be replaced.

With respect to rolling tool assemblies for support rollers, in addition to facing the problem of requiring customization for different crankshaft bearing sizes, the cam roller that fits between the side walls on either side of the crankshaft bearings needs to be appropriately sized to correspond to that of the crankshaft bearing. Currently the cam followers are sized to fit the rolling tool assembly for the support rollers that are used for a particular size or range of sizes of crankshaft bearings. Accordingly, if a different size and specifically different axial length of the crankshaft bearing requires a different size cam roller, a different support roller rolling tool assembly is required.

For changing the cam roller, its mounting fastener needs to be removed. The fastener can be a shoulder bolt that also serves as an axle for the cam roller. The shoulder bolt has its drive recess facing forwardly at the forward face of the cam roller, and thus the drive recess often times will be fouled and filled with metallic fines that are very difficult to dislodge from the drive recess. As such, it is also very difficult to replace the cam roller by removing the shoulder bolt. Instead, one approach has been to fracture the cam roller so that it can be gripped with a wrench and removed.

### SUMMARY OF THE INVENTION

In accordance with one aspect of the invention, a rolling tool assembly is provided that has a generally three-piece housing construction including a main, generally C-shaped body or frame member and a pair of opposing side plate members, that are fastened together to close off the open sides of the generally C-shaped body member for forming an interior space into which the remaining components of the rolling tool assembly can be mounted. In one alternative, the body member is made as a standard size component for a predetermined range of crankshaft bearing sizes with the side plate members being custom made so that the side plate members vary in predetermined dimensions thereof to correspond to a specific size of the crankshaft bearings in the predetermined range of differently sized crankshaft bearings. For example, a standard size body member is provided for use with smaller crankshaft bearings, and specifically pin bearings in the range of approximately 40 millimeters to approximately 55 millimeters in diameter, and another larger, standard size body member can be provided for pin bearings that vary from approximately 55 millimeters to approximately 75 millimeters in diameter. In these ranges, the size of the side plates can vary as the diameter and width or axial length of the pin bearings varies, as can be seen in Example 1 and the figures as will be discussed hereinafter.

Alternatively, the side plate members can be made to be of standard size while the generally C-shaped body member is custom made to vary in predetermined dimensions thereof to correspond to the size of the crankshaft bearing to be rolled, as depicted Example 2 and in the figures to be described hereinafter. In this approach, there would be standard size side plate members for a predetermined range of crankshaft bearing sizes while the generally C-shaped body member varies in its dimensions depending on the size of the crankshaft bearing to correspond to a specific diameter and width of the crankshaft bearings in the predetermined range of differently sized crankshaft bearings.

The use of either a standard size body member or side plate member provides advantages for the cost of manufacture of the rolling tool assembly since no longer do all the housing components have to be custom made for use with different diameter and/or axial length crankshaft bearings. By contrast, having a standard housing component allows for a large volume of this component, i.e. either the body member or side plate member, to be manufactured with the attendant cost savings this provides. To this end, low cost methods of manufacturing the standard housing component include both extrusion and molding processes. For forming the standard housing components, an elongate block or bar for forming multiple housing components therefrom can be extruded, molded, or machined which is then sectioned or cut to the standard width of the housing component for subsequent finish machining. The materials for the housing component can be any extrudable metallic or non-metallic material such as aluminum or a composite material, or a moldable material. The housing component could also be a cast part which would provide advantages in that the part would only require a single mold for the standard housing component for each range of bearing sizes for which it is adapted to be used. Alternatively, the part could subject to high volume machining and be of any metallic material suitable for such purpose such as steel or a steel alloy.

As mentioned earlier, rather than having the generally C-shaped body member be the standard housing component, the side plate members can be standard while the tool body varies in its predetermined dimensions to correspond to the different size crankshaft bearings to be machined. In this instance, since the housing assembly is of three components, and two of the components, i.e. the side plate members, will be standard and identical to one another, this approach provides the benefit of having a greater number of standard size parts per rolling tool assembly over having the single body member be the standard housing component.

In addition, the configuration of the housing components also provides advantages in that it allows these components to be extruded, molded or machined as a long bar/sectionable stock regardless of whether the component is to be the standard size housing component or the variable size housing component. For example, the generally C-shaped body member can be formed by extruding, molding, or machining an elongated bar or block having a generally C-shaped profile which is then cut or sectioned in the different width sizes that are needed for the generally C-shaped body member to be used with standard size side plate members.

In another aspect, the rolling tool assembly having the work rollers includes a work roller cartridge which carries the work rollers in a modular unit that can be readily removed when the work rollers are worn for being replaced with another work roller cartridge without having to disassemble the cage members from the housing for the rolling tool assembly. Also, the work roller cartridge can be easily removed for inspection of the back-up roller that provides a roller bearing for the work rollers. With the work roller cartridge removed from the housing, an operator can determine whether the back-up roller rotates freely so that it is properly functioning as a roller bearing. Preferably, the work roller cartridge includes a holder to which cage retainer members and the work rollers are mounted with the holder being removably fastened to the housing of the rolling tool assembly. In this manner, the work rollers can be replaced by removing the fasteners securing the holder, and thus the work roller cartridge, to the tool housing.

More specifically, with the three-piece housing construction as described above, the cartridge holder can be fastened to an interior, central flange portion of the generally C-shaped body member, at either end of the holder. Thus, by removing the end fasteners from the ends of the work roller cartridge, the cartridge can be quickly replaced with another work roller cartridge having the cage retainer members and work rollers already mounted thereto without requiring that the cage members and the work roller be individually removed from the housing for this purpose.

In another aspect, the cage retainer members are configured to be reversible so that the work roller bearing surfaces can be changed without the need for replacing the cage member. In this regard, the cage members each have both of their ends identically configured for receiving a pair of work rollers. More particularly, the ends each are configured with a pair of pockets that have the work rollers bearing surfaces therein so that when the bearing surfaces of one set of the pockets becomes worn, the cage member can be removed from the rolling tool assembly and reoriented so that the other end including the work roller pockets therein are positioned for receiving the work rollers therein.

In a preferred form, the reversible cage members described above are provided with the work roller cartridge previously described. For easily changing the cage members, they are secured to the holder of the work roller cartridge via removable fasteners. The holder includes a pair of through openings, one for being used by each of the cage members. The cage members are each provided with a pair of through openings so that one or the other of the openings can be aligned with an associated one of the holder openings for receiving a fastener therein. Thus, when the cage member is secured in a first orientation with a first set of the pockets receiving the work rollers therein, a first one of its openings will be aligned with the associated one of the holder openings. For reversing the cage member so that the other set of pockets receive the work rollers, the fasteners are removed to disassemble the cage member from the holder which remains secured to the housing of the roller tool assembly, the cage member is turned to properly orient the other end pockets for receiving the work rollers therein which will cause the other opening of the cage member to be aligned with the associated one of the holder openings, and the fastener is inserted into the aligned openings to secure the cage member to the holder. In this manner, the reversible cage members herein essentially have double the life over the prior cage members that had only a single set of work roller pockets.

Rather than using the work roller cartridge, the three-piece housing herein can be configured to have cage members mounted directly thereto. In this instance, the side plate members are preferably the standard housing component while the C-shaped body member varies in its predetermined dimensions according to the size of the bearing being rolled. The side plate members can have a round or annular configuration and one of the annular side plate members can be configured to be secured to the assembled body member and other annular side plate member to open the housing by a twist release motion.

As is known, rolling tool assemblies for support rollers include a cam roller that is adapted to engage the side walls on either side of the bearing engaged by the upper and lower support rollers. Generally, in prior rolling tool assemblies for support rollers, the cam follower was not removed since these rolling tool assemblies were custom made to fit different sizes of crankshaft bearings. Should the cam followers need replacement due to wear, its removal could be extremely difficult as previously described. Herein, the cam follower is carried in a modular cartridge so that it can be easily replaced without having to entirely disassemble the housing of the rolling tool assembly. Further, the housing components are configured so that different sizes of cam followers can be assembled therewith. Thus, the cam follower cartridge provides advantages in its ease of removal and replacement with the tool housing described herein.

More particularly, with the three-piece housing described earlier, the cam follower cartridge can be accessed by simply removing one of the side plate members and sliding the cam follower cartridge out of the open sided rolling tool assembly and replacing it with a different cam follower cartridge. In a preferred form, the cam follower cartridge includes a cam follower and a T-shaped guide block that is received in a corresponding shaped cavity in the housing assembly to be retained therein. The cam follower has an enlarged cam head member and a rearwardly extending shaft receive in a bore of the guide block so that the cam member projects forwardly into the space between the bearing side walls with the guide block received in its housing cavity. Thus, when a different size bearing is to be rolled, the present rolling tool assembly for the support rollers can have either the same standard, generally C-shaped body member or standard plate members, with the remaining components than selected based on the size of the bearing including the cam follower cartridge and the cam follower carried thereby.

### BRIEF DESCRIPTION OF THE DRAWINGS

FIGS. 1A-1D are perspective and elevation views of a rolling tool assembly for work rollers for rolling a smaller crankshaft bearing;

FIGS. 2A-2C are perspective views of a generally C-shaped body member of the rolling tool assembly of FIGS. 1A-1D;

FIGS. 3A and 3B are perspective views one of the side plate members of the rolling tool assembly of FIGS. 1A-1D;

FIGS. 4A and 4B are perspective views of the other side plate member of the rolling tool assembly of FIGS. 1A-1D;

FIGS. 5A and 5B are perspective and elevation views of an internal support roller for the work rollers of the rolling tool assembly of FIGS. 1A-1D;

FIGS. 6A-6D are perspective and elevation views of a modular cartridge for the work rollers;

FIGS. 7A and 7B are perspective views of a holder for the work roller cartridge;

FIGS. 8A-8D are perspective, elevation, and plan views of one of the cage retainer members of the work roller cartridge;

FIGS. 9A-9C are perspective views of another rolling tool assembly for work rollers for a larger crankshaft bearing;

FIG. 10 is a perspective view of a generally C-shaped body member of the rolling tool assembly of FIGS. 9A-9C, which is identical to the C-shaped body member illustrated in FIGS. 2A-2C of the rolling tool assembly of FIGS. 1A-1D;

FIG. 11 is a perspective view of one of the side plate members of the rolling tool assembly of FIGS. 9A-9C;

FIG. 12 is a perspective view of another rolling tool assembly for work rollers for smaller crankshaft bearings;

FIG. 13 is a perspective view of a generally C-shaped body member of the rolling tool assembly of FIG. 12;

FIG. 14 is a perspective view of one of the side plate members of the rolling tool assembly of FIG. 12;

FIG. 15 is a perspective view of another rolling tool assembly for work rollers for larger crankshaft bearings;

FIG. 16 is a perspective view of a generally C-shaped body member of the rolling tool assembly of FIG. 15;

FIG. 17 is a perspective view of one of the side plate members of the rolling tool assembly of FIG. 15, which is identical to the side plate member illustrated in FIG. 14 of the rolling tool assembly of FIG. 12;

FIGS. 18A-18G are perspective and elevation views of another rolling tool assembly for support rollers for a smaller size crankshaft bearing;

FIGS. 19A-19C are perspective views of a generally C-shaped body member of the rolling tool assembly of FIGS. 18A-18G;

FIGS. 20A and 20B are perspective views of one of the side plate members of the rolling tool assembly of FIGS. 18A-18G;

FIGS. 21A and 21B are perspective views of the other side plate member for the rolling tool assembly of FIGS. 18A-18G;

FIG. 22 is a perspective view of a modular cam follower cartridge;

FIG. 23 is a perspective view of a cam follower carried by the cam follower cartridge of FIG. 22;

FIGS. 24A-24C are perspective views of another rolling tool assembly for support rollers for a larger crankshaft bearing;

FIG. 25 is a perspective view of a generally C-shaped body member of the rolling tool assembly of FIGS. 24A-24C, which is identical to the C-shaped body member illustrated in FIGS. 19A-19C of the rolling tool assembly of FIGS. 18A-18G;

FIGS. 26A and 26B are perspective views of one of the side plate members of the rolling tool assembly of FIGS. 24A-24C;

FIG. 27 is a perspective view of another rolling tool assembly for support rollers for a smaller crankshaft bearing;

FIGS. 28A and 28B are perspective views of a generally C-shaped body member of the rolling tool assembly of FIG. 27;

FIG. 29 is a perspective view of one of the side plate members of the rolling tool assembly of FIG. 27;

FIG. 30 is a perspective view of another rolling tool assembly for support rollers for larger crankshaft bearings;

FIGS. 31A and 31B are perspective views of a generally C-shaped body member of the rolling tool assembly of FIG. 30;

FIG. 32 is a perspective view of one of the side plate members of the rolling tool assembly of FIG. 30, which is identical to the side plate member illustrated in FIG. 29 of the rolling tool assembly of FIG. 27;

FIGS. 33A and 33B are perspective views of a prior art rolling tool assembly for support rollers; and

FIGS. 34A and 34B are elevational and cross-sectional views of an alternative rolling tool assembly slowing a generally C-shaped body configured to connect to generally annular shaped side plate members.

### DETAILED DESCRIPTION OF THE PREFERRED EMBODIMENTS

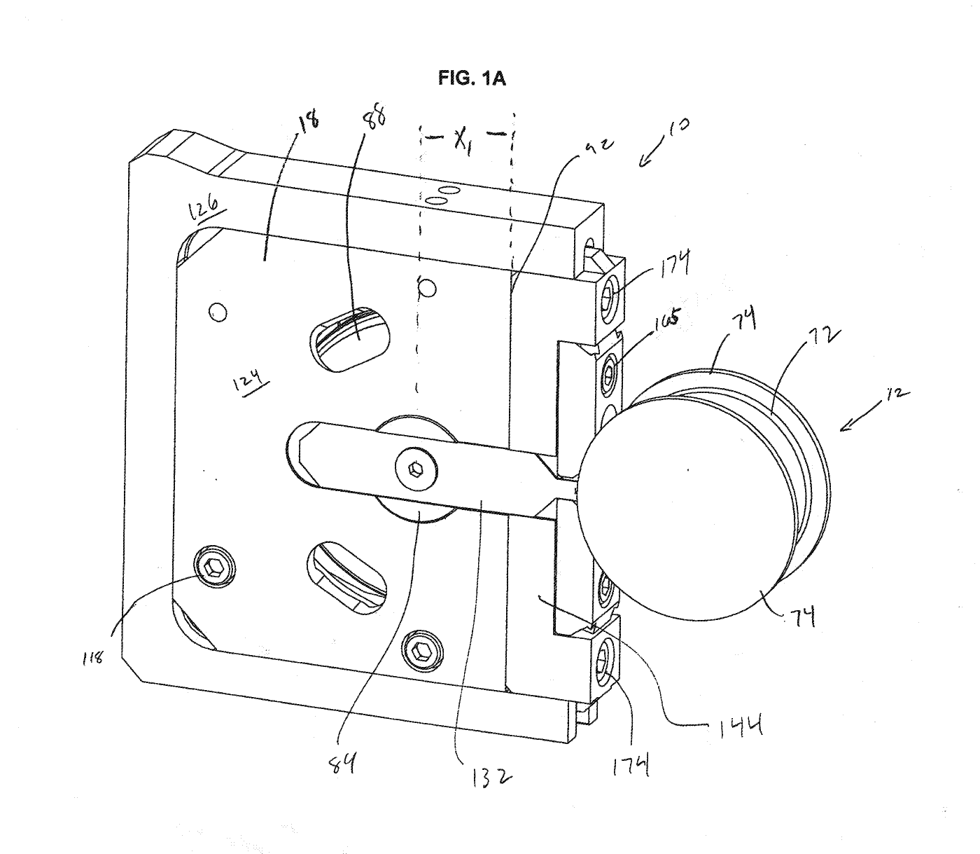

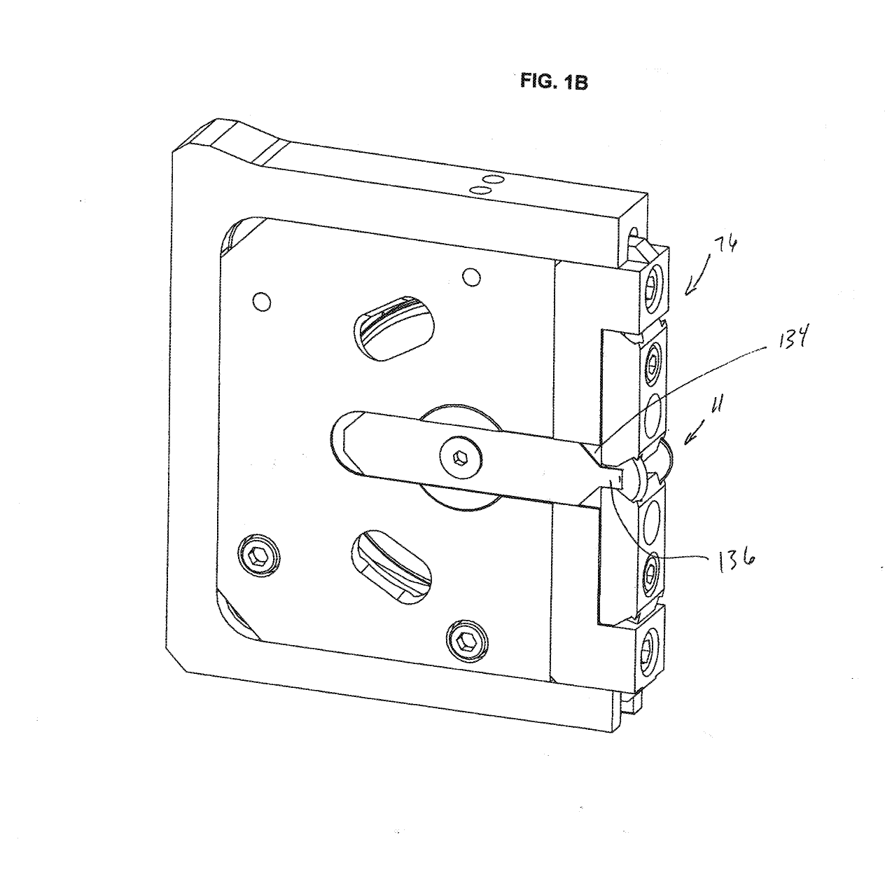

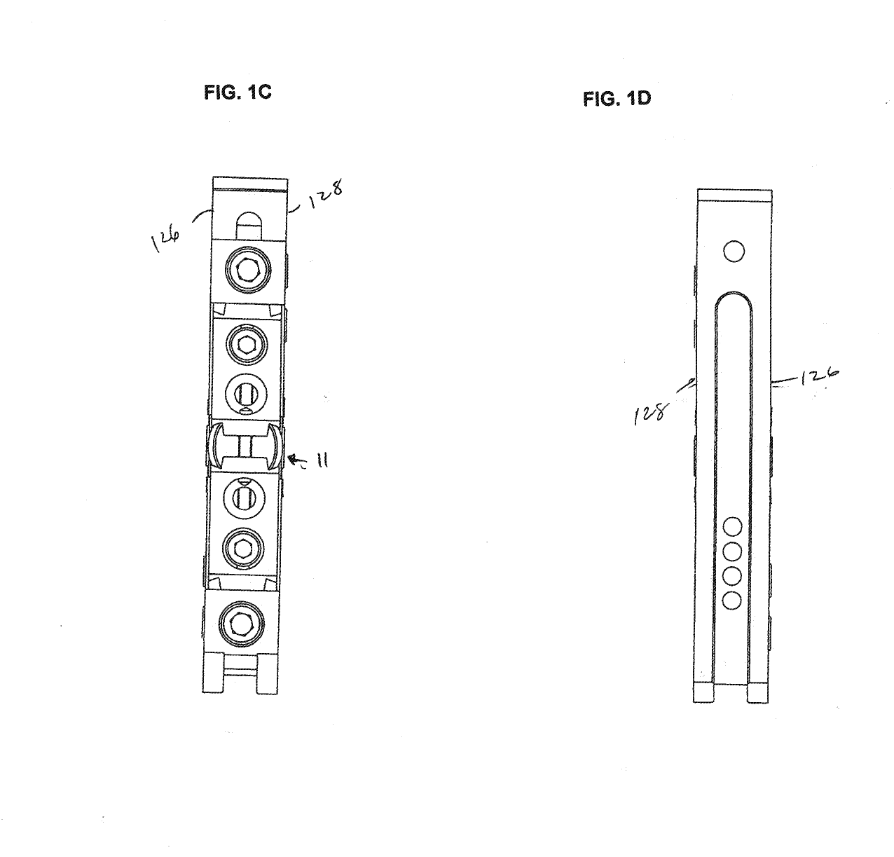

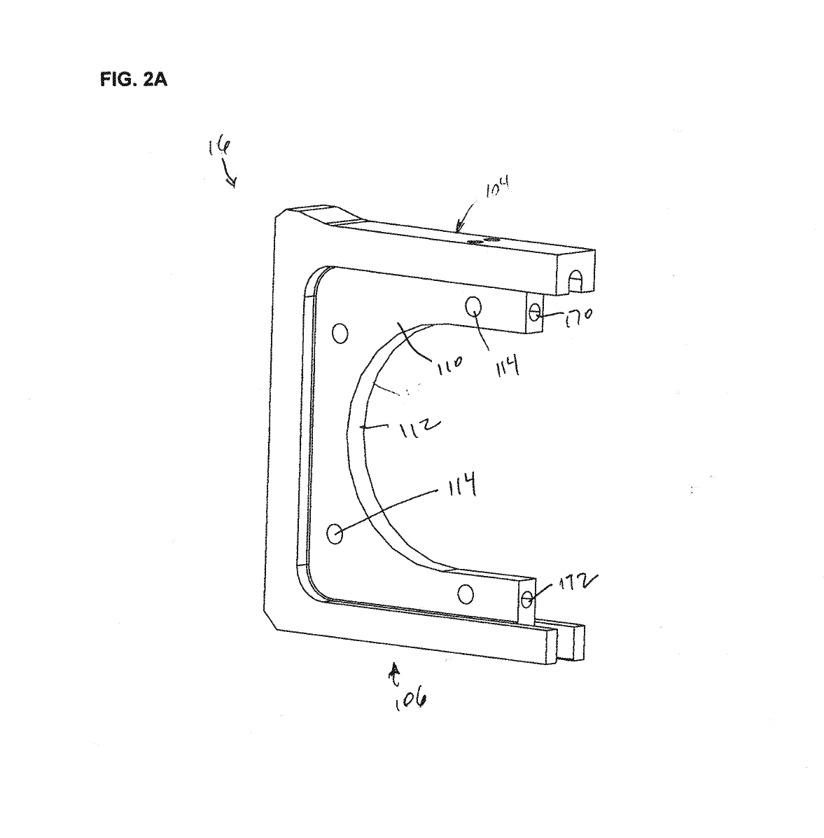

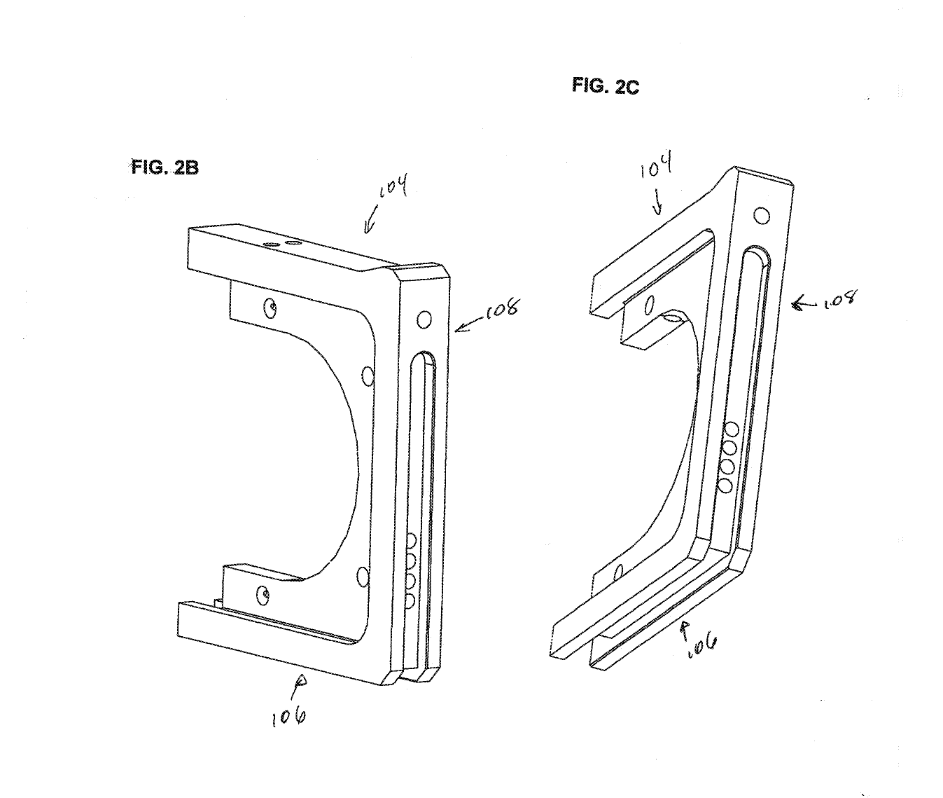

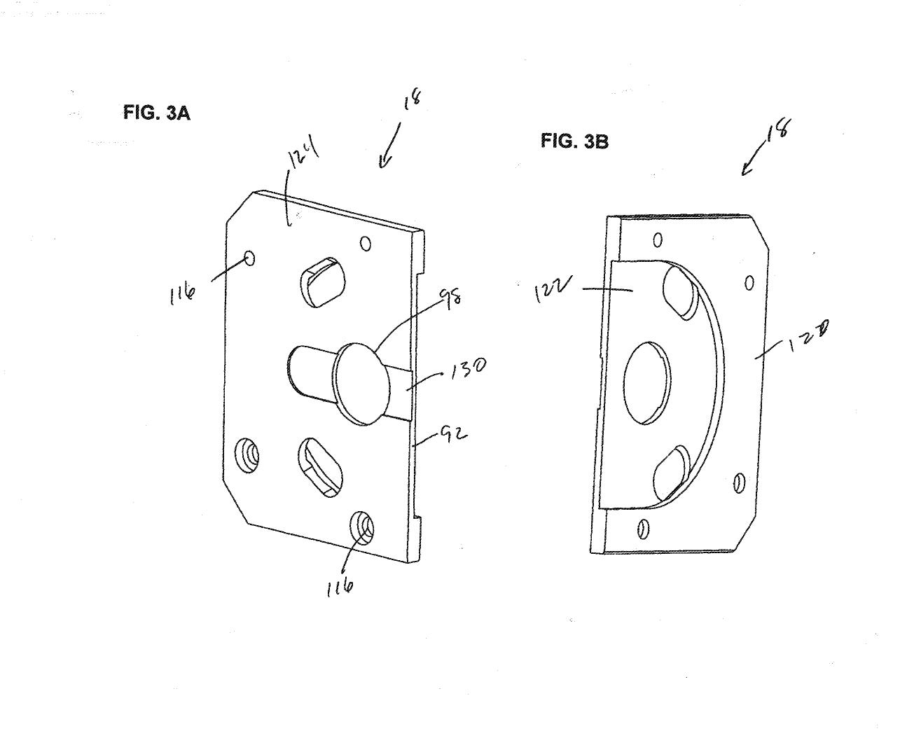

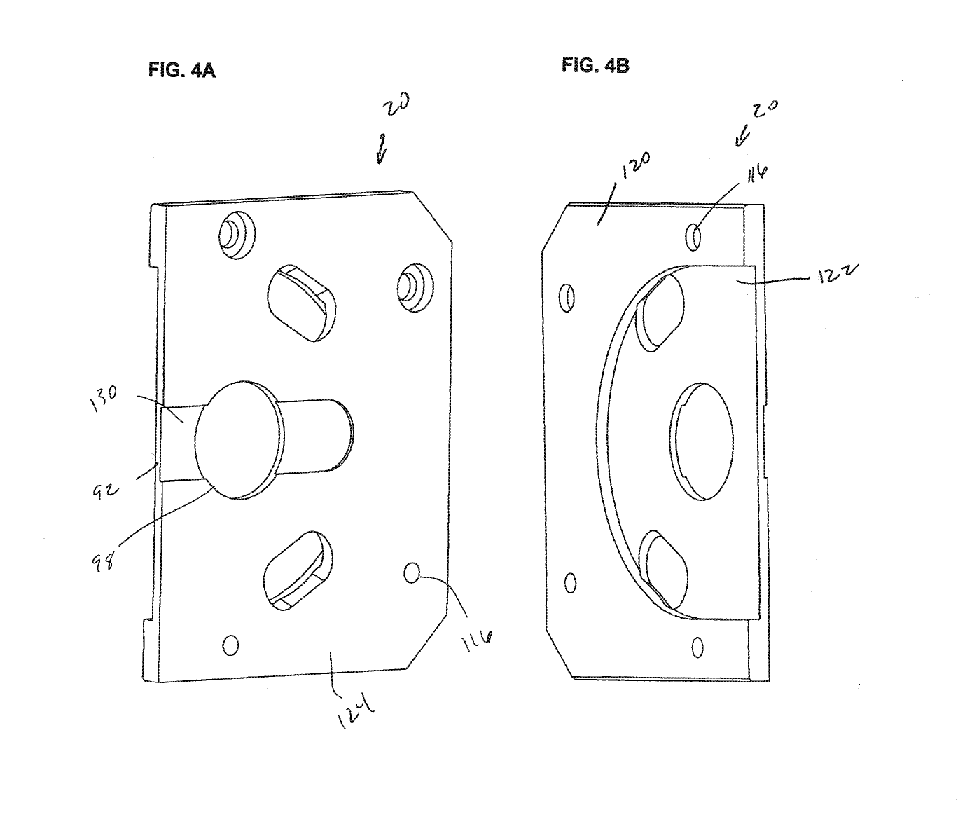

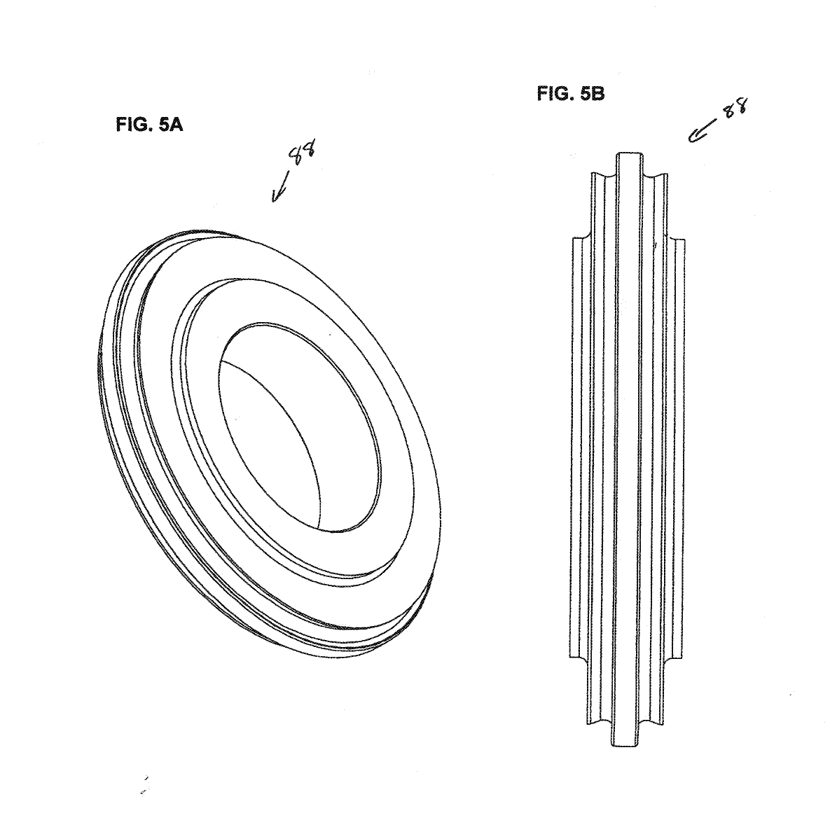

In FIGS. 1A-1D, a rolling tool assembly 10 for work rollers 11 is illustrated for rolling smaller crankshaft bearings 12. The rolling tool assembly 10 has a three-piece housing construction for forming the housing or housing assembly 14 thereof. In this regard, the housing assembly 14 includes a main, generally C-shaped body or frame member 16 (FIGS. 2A-2C), and a pair of opposing side plate members including left side plate member 18 (FIGS. 3A and 3B) and identical right side plate member 20 (FIGS. 4A and 4B). With the three-piece housing assembly 14, either the main body member 16 or the side plate members 18 and 20 can be formed as standard components for use with roller tool assemblies for different sizes of crankshaft bearings.

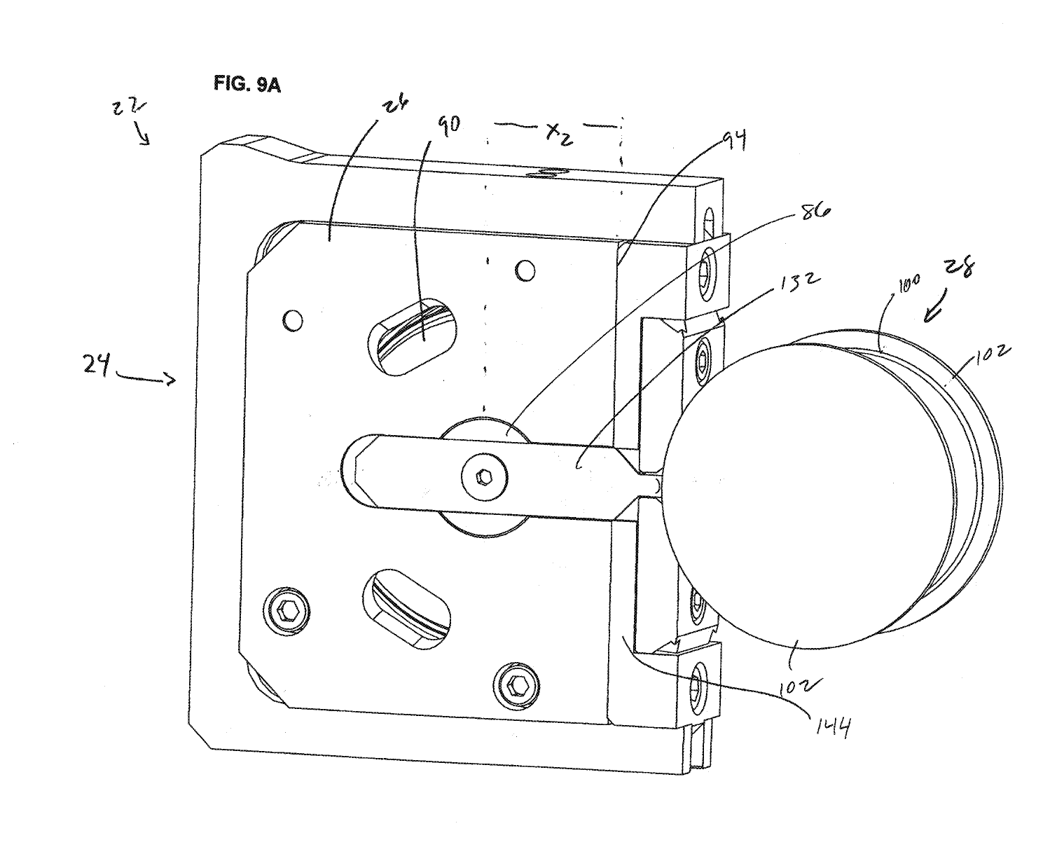

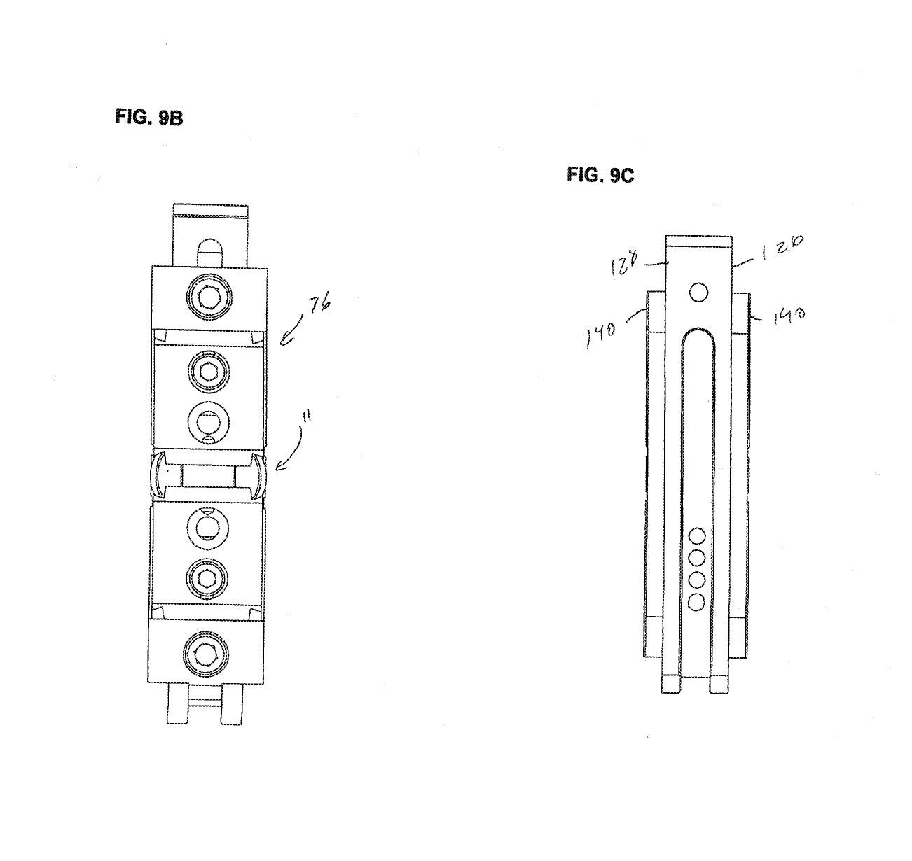

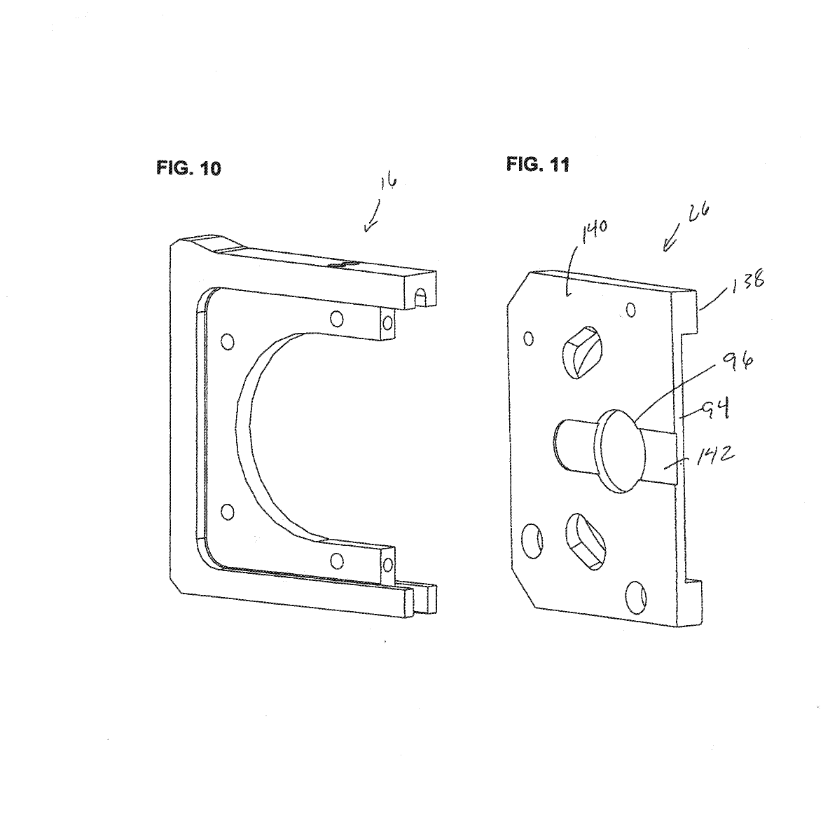

For example, FIGS. 9A-9C show another rolling tool assembly 22 for work rollers 11 that is adapted to roll larger crankshaft bearings 28 and which employs the same three-piece housing construction for its housing assembly 24. In this regard, the housing assembly 24 has the same generally C-shaped main body member 16 (FIG. 10) as used in the housing assembly 14, whereas the opposing side plate members 26 (one of which is shown in FIG. 11) has different dimensions than the side plate members 18 and 20 for adapting the housing assembly 24 of the rolling tool assembly 22 to be used with the larger crankshaft bearing 28.

Example 1 below shows a comparison between the rolling tool assemblies 10 and 22 where the body member 24 is standardized and the respective plate members 18, 20 and 26 are customized.

### EXAMPLE 1

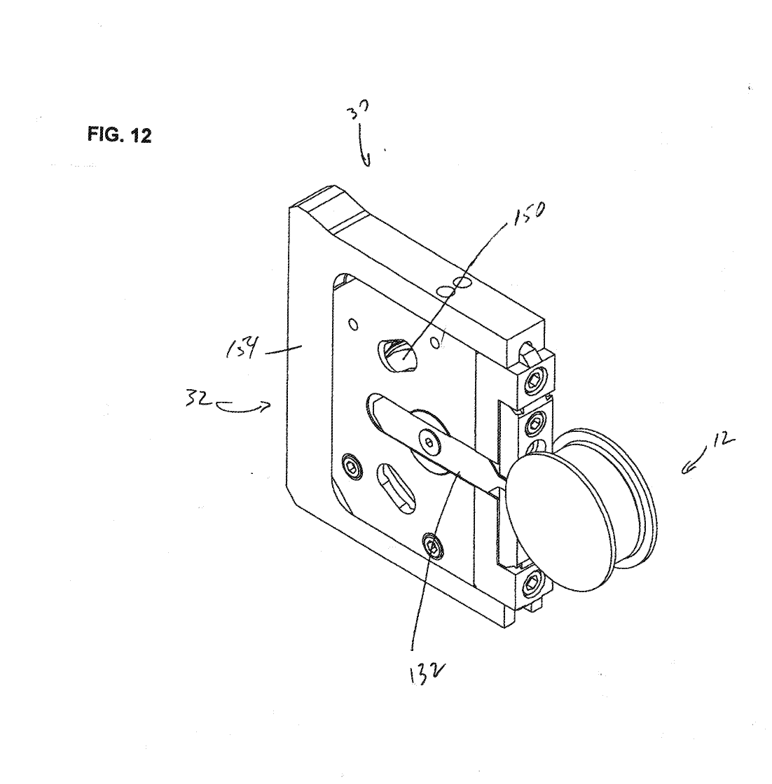

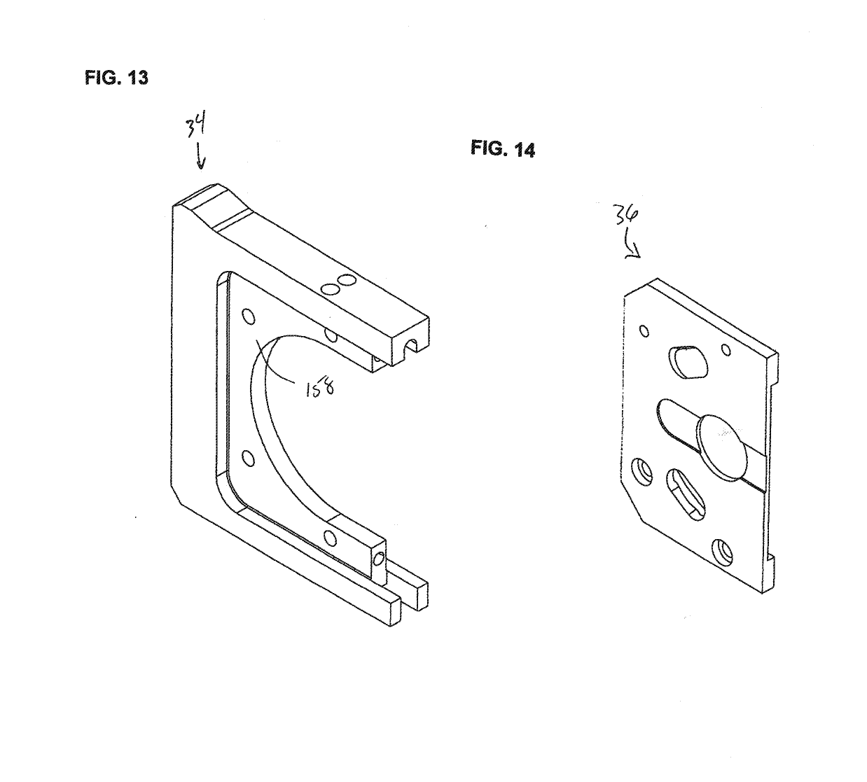

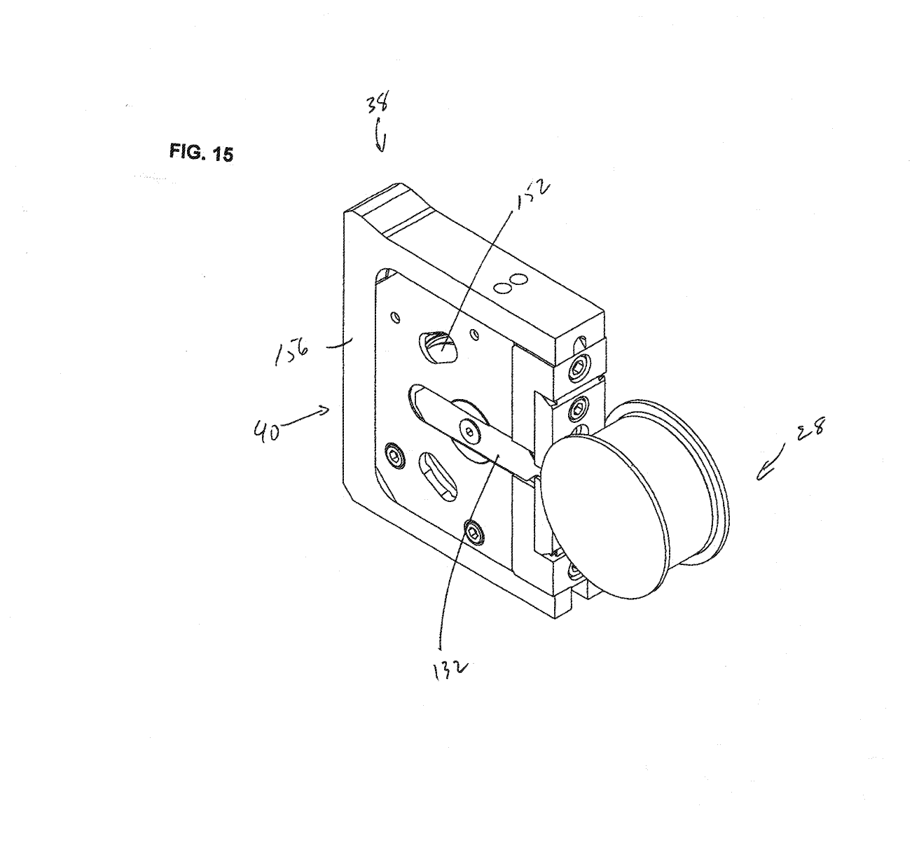

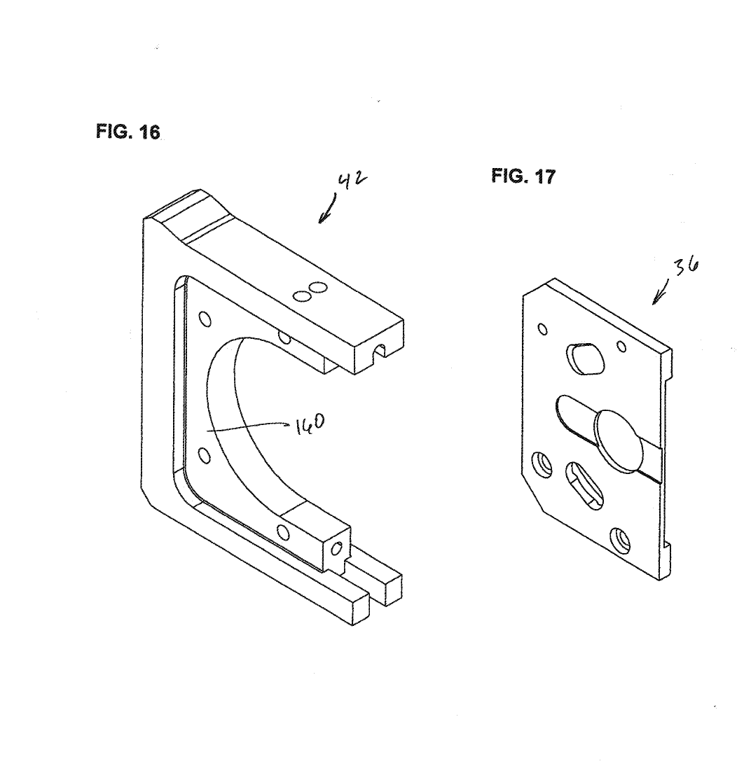

Alternatively, rather than having the main body member 16 be the standard component of the housing assembly, the three-piece housing construction also allows for the side plate members to be standardized for use in housing assemblies adapted for rolling different sizes of bearings such as small bearing 12 (e.g. crankshaft pin bearing 12 in the range of approximately 40 millimeters to approximately 55 millimeters in diameter) and large bearing 28 (e.g., crankshaft pin bearing 28 in the range of approximately 55 millimeters to approximately 75 millimeters in diameter). More particularly, FIG. 12 shows a rolling tool assembly 30 for work rollers 11 having a three-piece housing construction for its housing assembly 32 adapted for rolling the smaller crankshaft bearing 12 including a main, generally C-shaped body member 34 (FIG. 13) and a pair of opposing side plate members 36 (one of which is shown in FIG. 14). FIG. 15 is directed to another rolling tool assembly 38 adapted for rolling the larger crankshaft bearing 28 which also has the three-piece housing construction for its housing assembly 40. The three-piece housing assembly 40 utilizes the same side plate members 36 (FIG. 17) as the housing assembly 32 whereas its generally C-shaped body member 42 (FIG. 16) varies in its dimensions for adapting the housing assembly 40 for the rolling tool assembly 38 for rolling the larger crankshaft bearing 28.

Example 2 below shows a comparison between the rolling tool assemblies 30 and 38 where the side plate members 36 are standardized and the respective body members 34 and 42 are customized.

### EXAMPLE 2

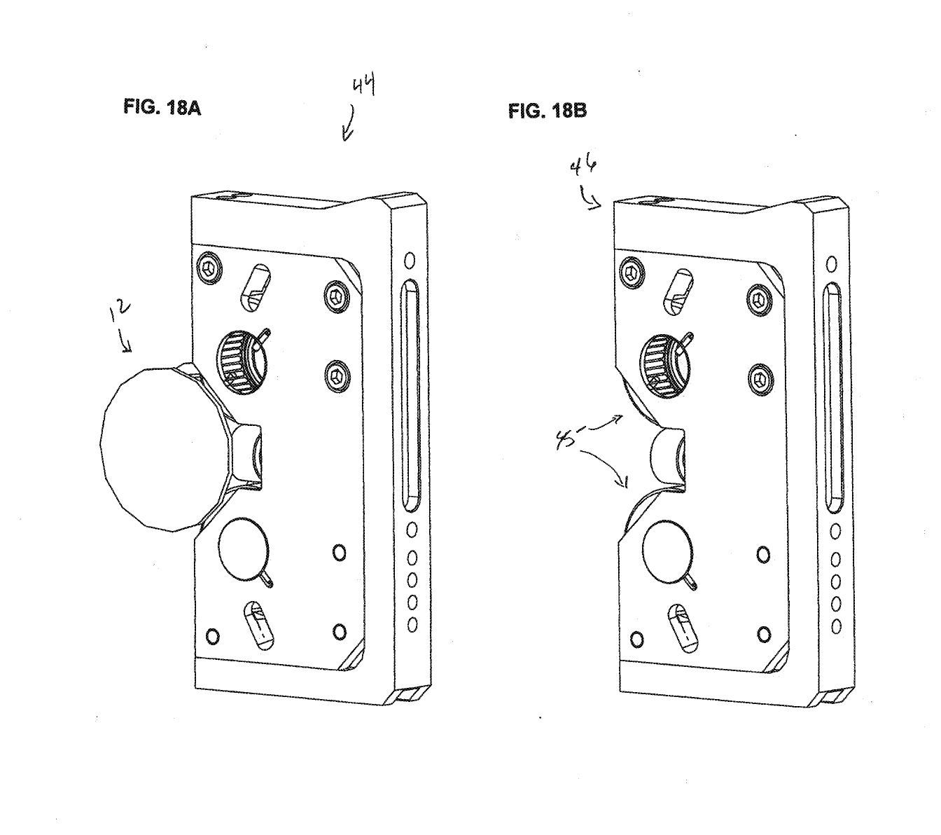

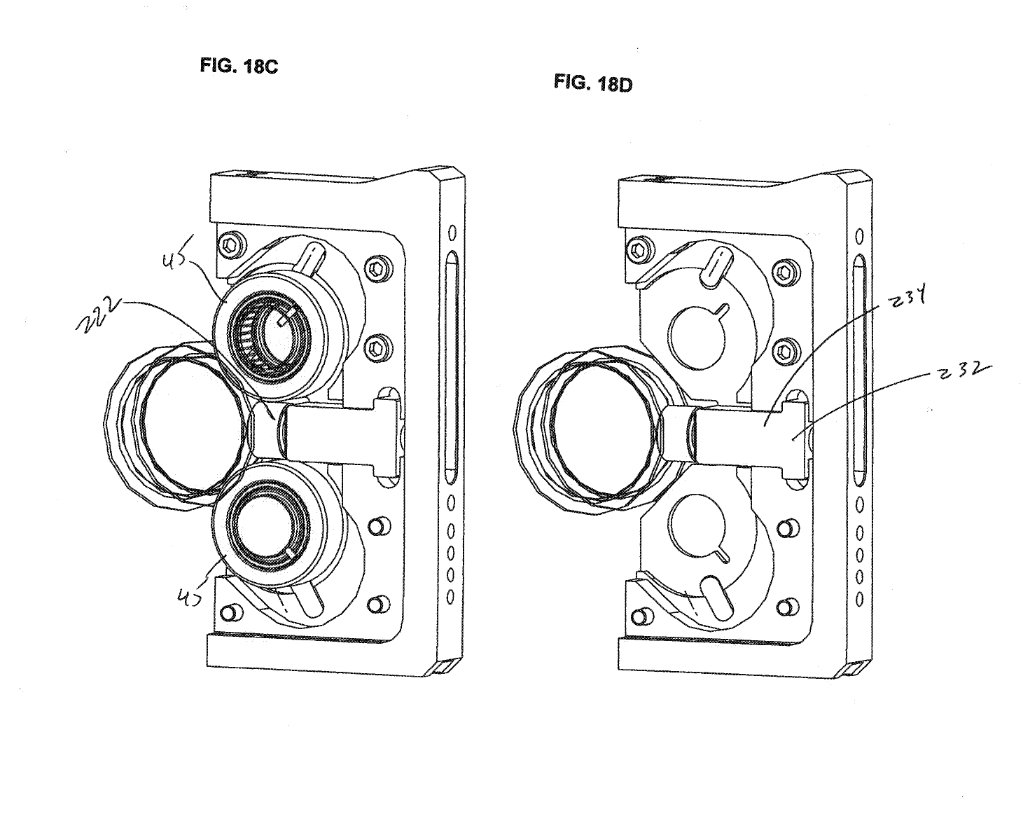

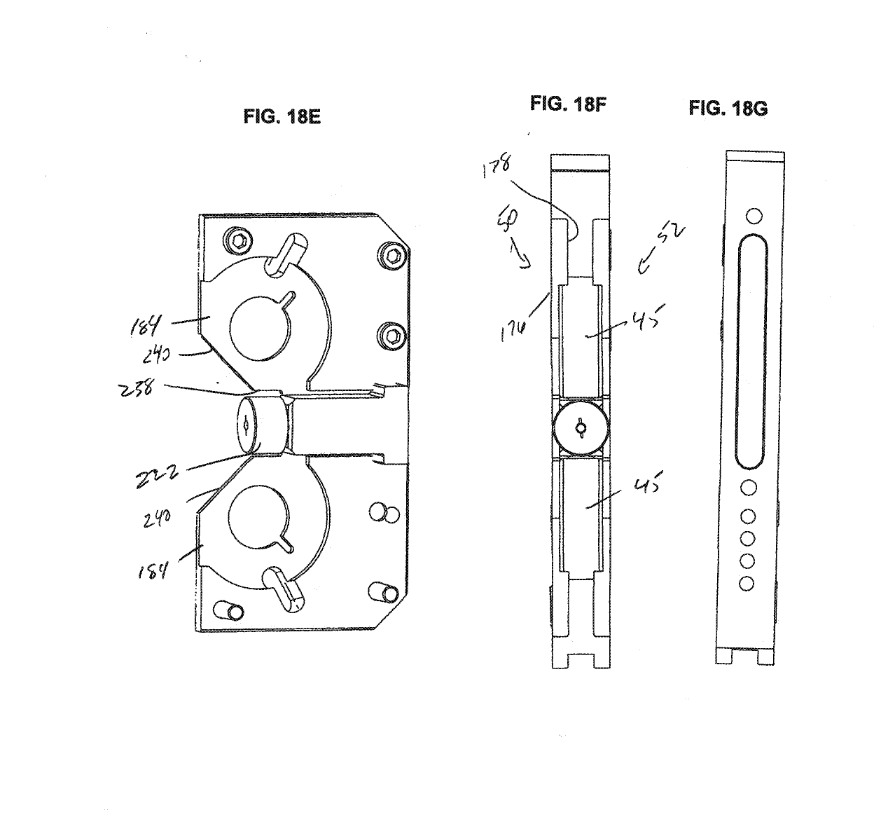

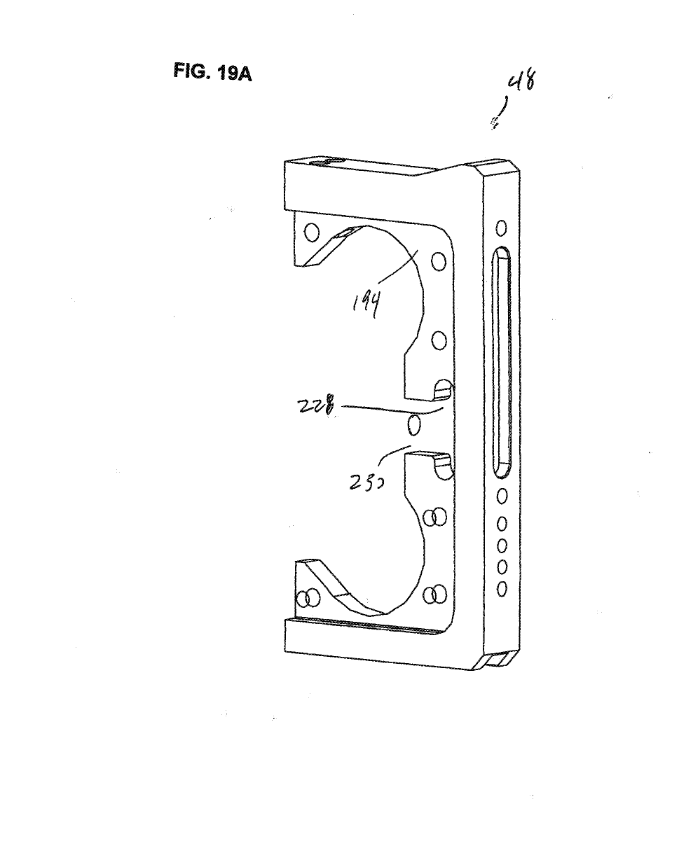

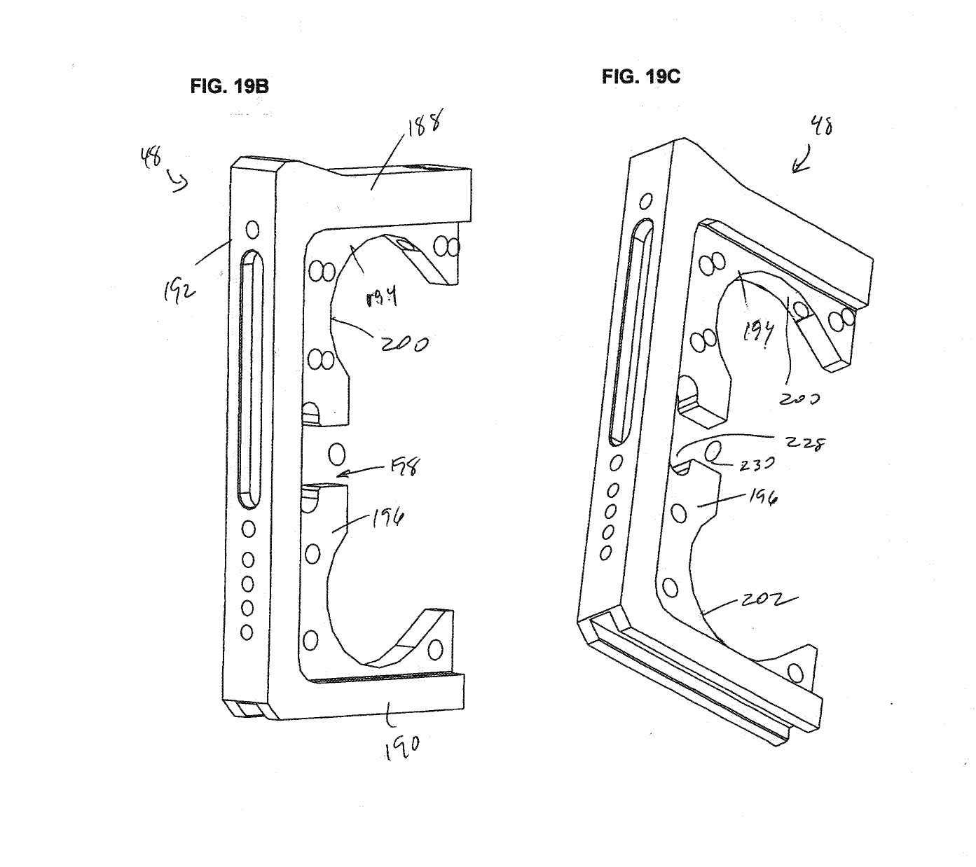

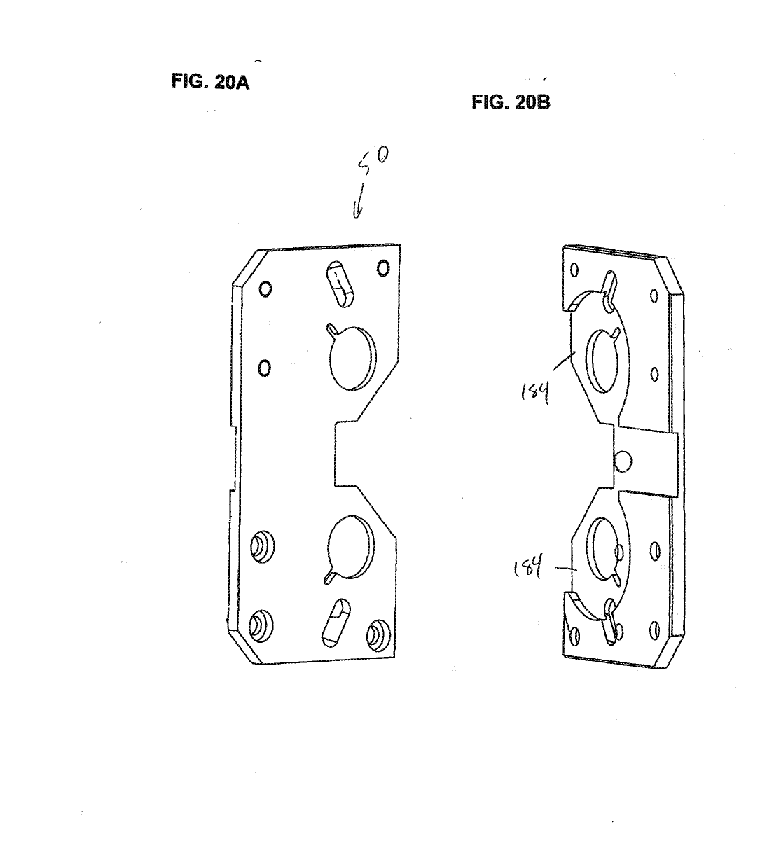

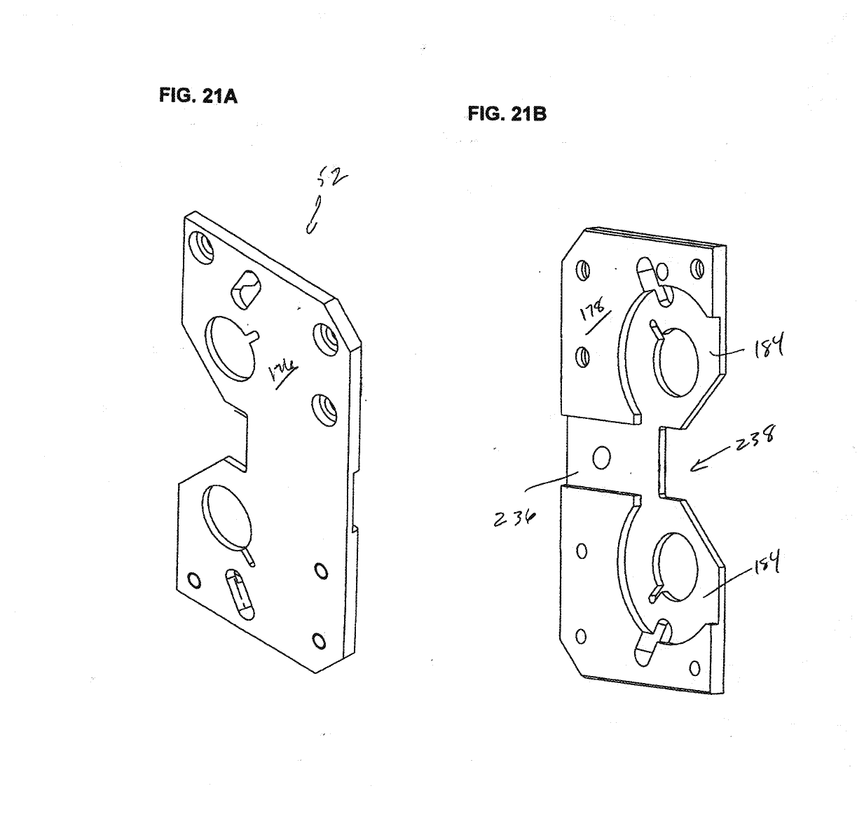

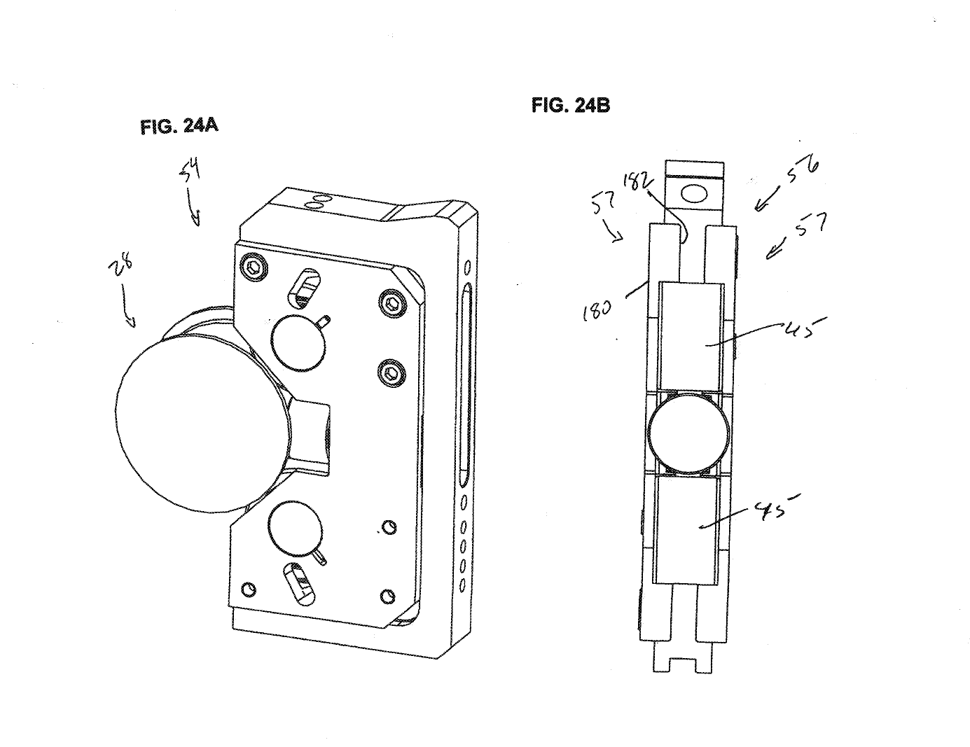

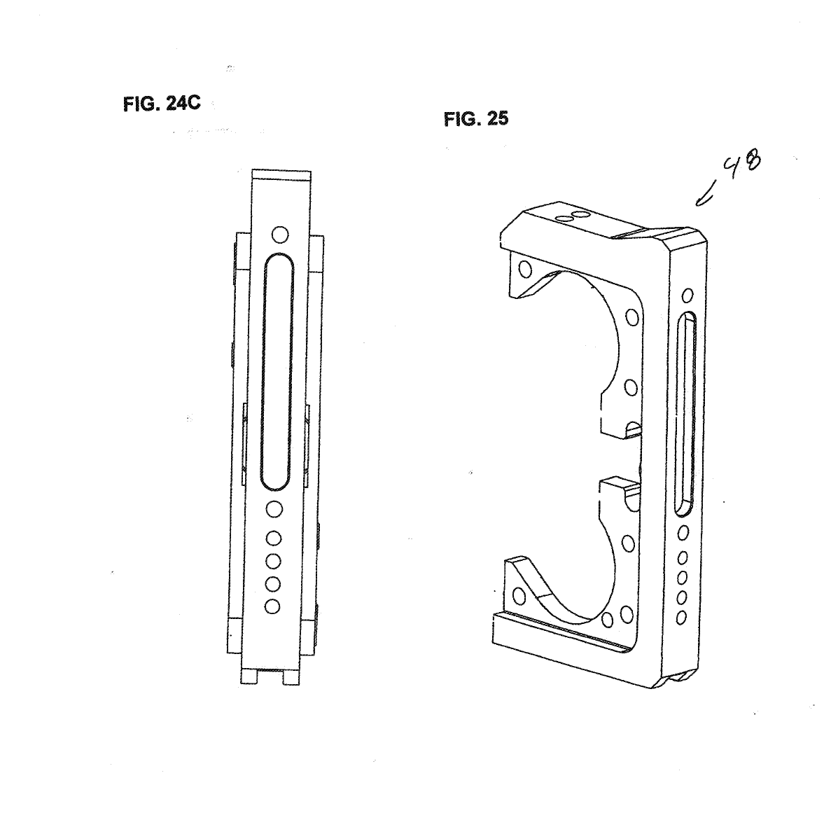

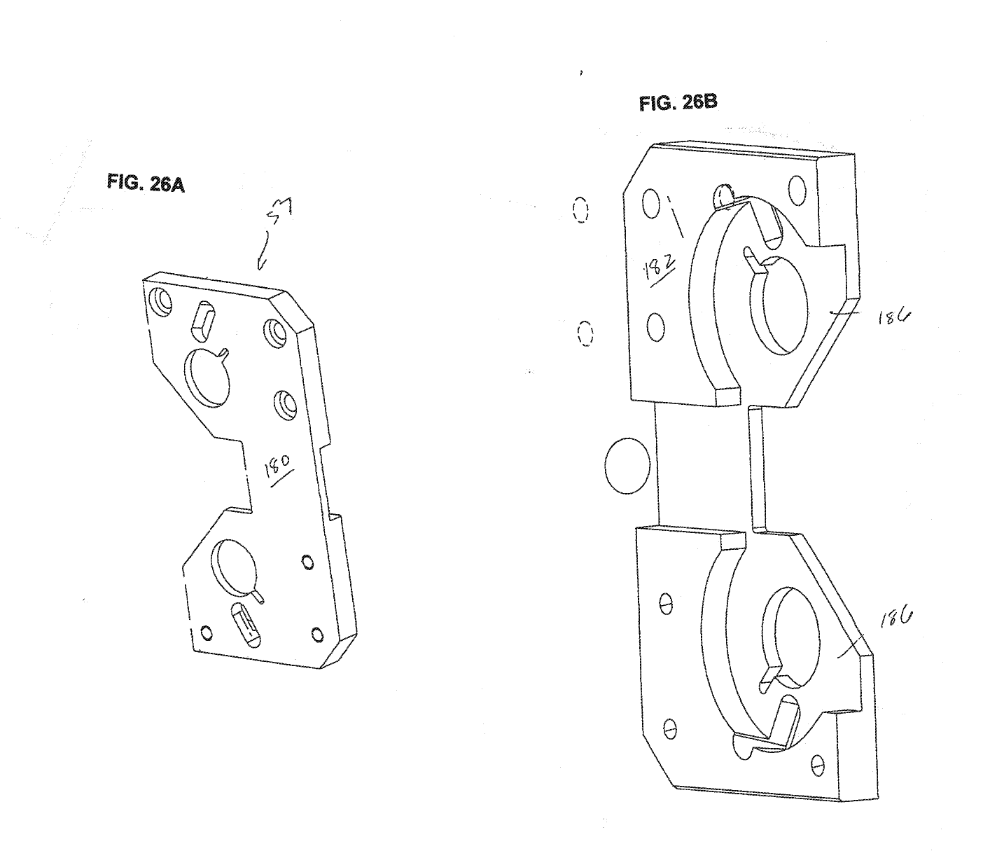

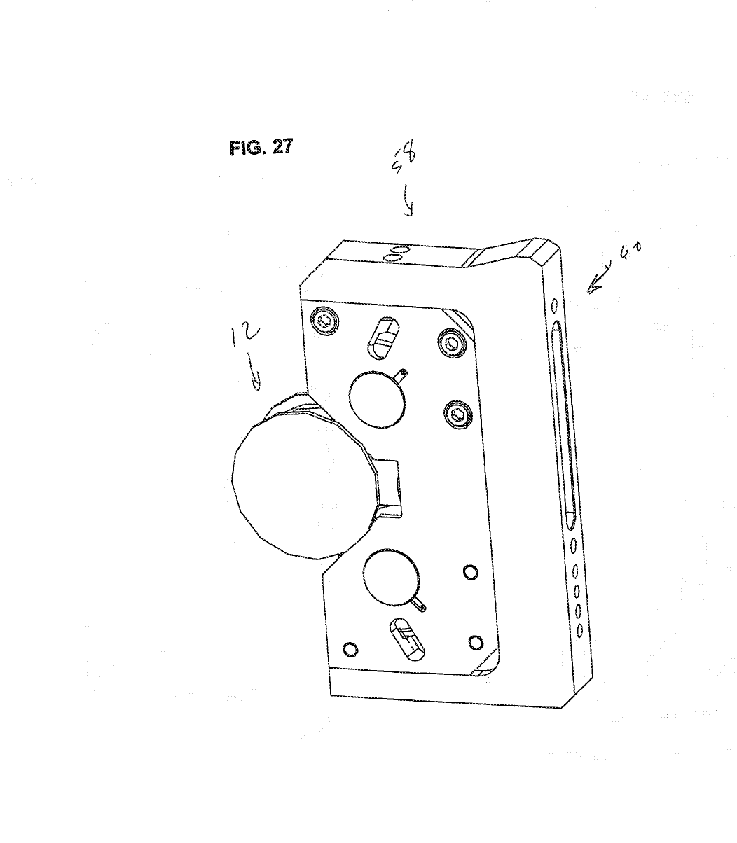

A similar approach is taken for the rolling tool assemblies for support rollers as described hereinafter. In FIGS. 18A-18G, a rolling tool assembly 44 for support rollers 45 is illustrated for rolling the smaller crankshaft bearings 12. The rolling tool assembly 44 has a three-piece housing construction for its housing assembly 46 including a main, generally C-shaped body member 48 (FIGS. 19A-19C) and opposing side plate members including left side plate member 50 (FIGS. 20A and 20B) and right side plate member 52 (FIGS. 21A and 21B). As with the side plate members for the previously described rolling tool assemblies for the work rollers 11, the left and right side plate members 50 and 52 can be of identical construction. FIGS. 24A-24C show another rolling tool assembly 54 for support rollers 45 adapted to be used with the larger crankshaft bearing 28 and having the same three-piece housing construction for its housing assembly 56. The three-piece housing assembly 56 has the same generally C-shaped body member 42 (FIG. 25) as used with the three-piece housing assembly 40 for the previously described rolling tool assembly 38. However, the housing assembly 56 has side plate members 57 (one of which is shown in FIGS. 26A and 26B) with different dimensions than the side plate members 50 and 52 to adapt the housing assembly 56 of the rolling tool assembly 54 to be used for rolling the larger size crankshaft bearing 28.

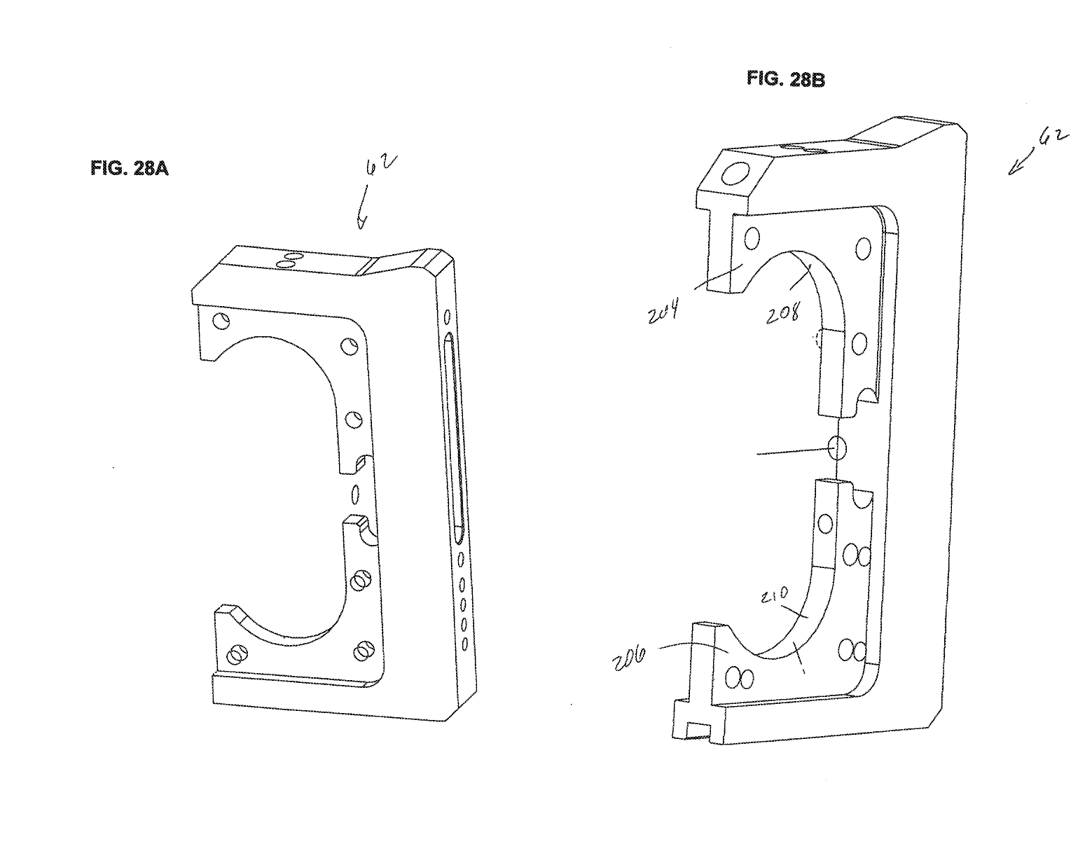

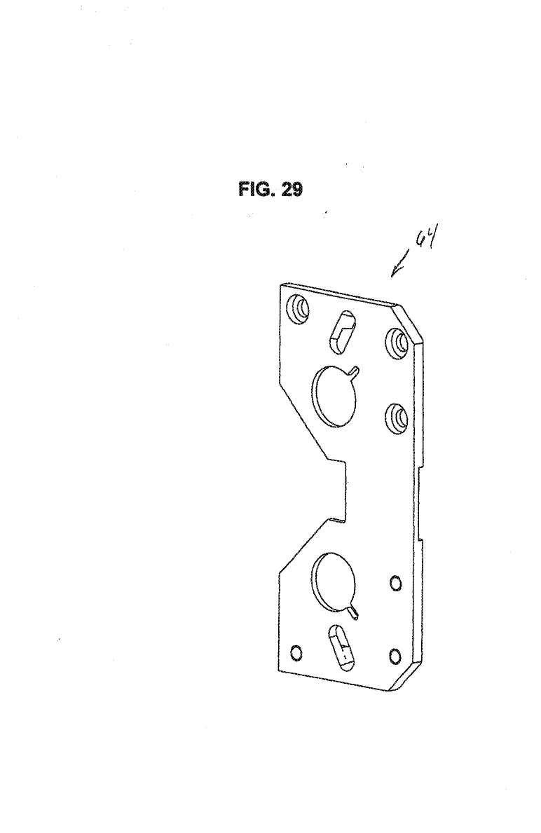

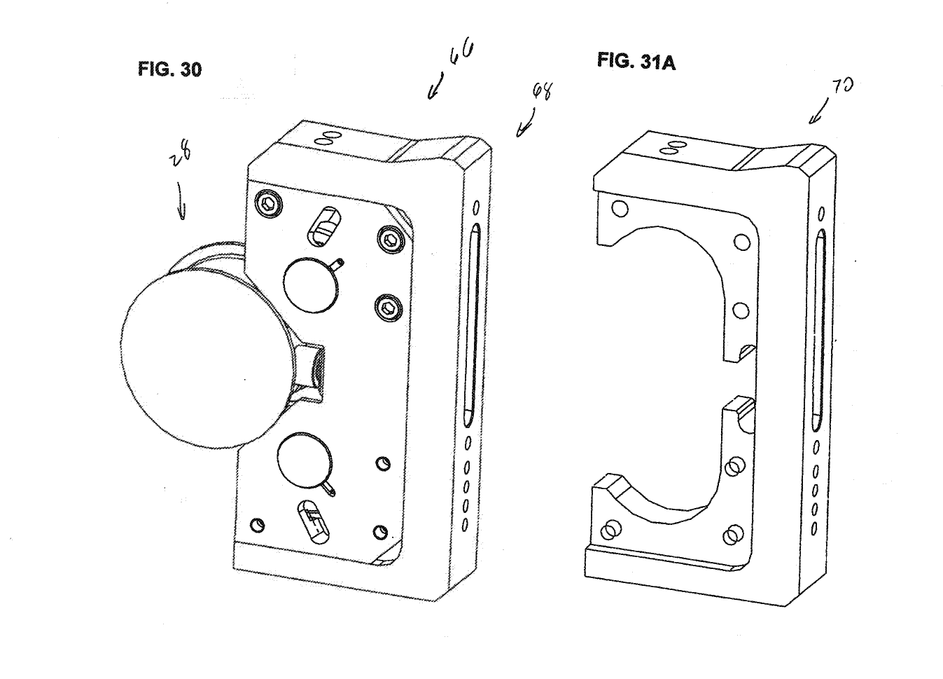

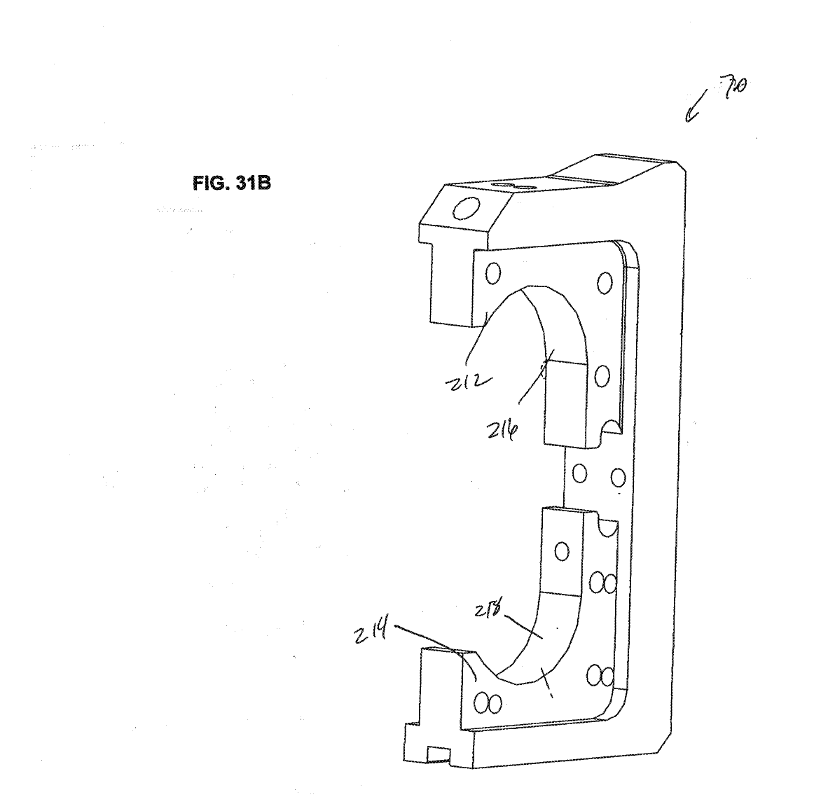

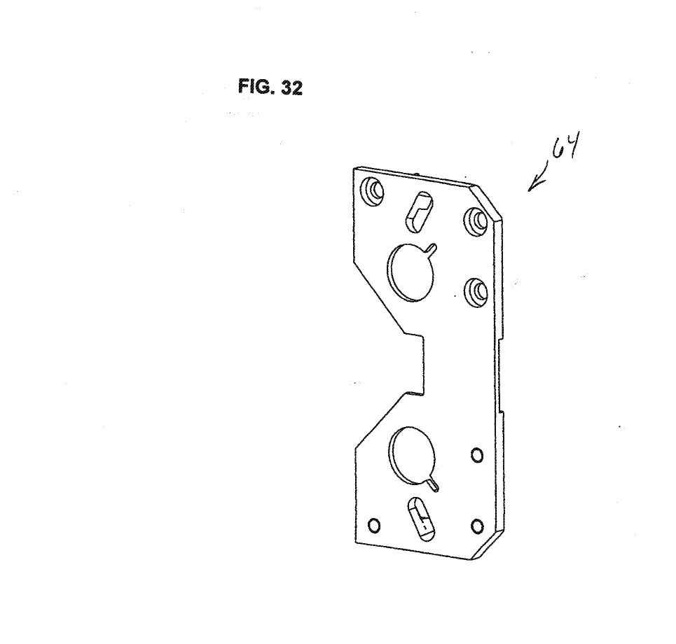

Like the housing tool assemblies for the rolling tools, rather than having the standard component be the generally C-shaped body member 48, the rolling tool assemblies for the support rollers 45 can have a three-piece housing construction where the standard component is the side plate members. More particularly, FIG. 27 shows a rolling tool assembly 58 for support rollers 45 having a three-piece housing construction for housing assembly 60 including a generally C-shaped body member 62 (FIGS. 28A and 28B) and opposing side plate members 64 (one of which is shown in FIG. 29), adapted for rolling the smaller crankshaft bearing 12. For rolling the larger crankshaft bearing 28, a rolling tool assembly 66 (FIG. 30) for the support rollers 45 is provided having a three-piece housing construction for its housing assembly 68 including a C-shaped body member 70 (FIGS. 31A and 31B) and the same opposing side plate members 64 (one of which is shown in FIG. 32) as used with the three-piece housing assembly 60 for rolling tool assembly 58. In this instance, it is the C-shaped body members 62 and 70 that vary in their dimensions according to the size of the crankshaft bearing that is to be rolled.

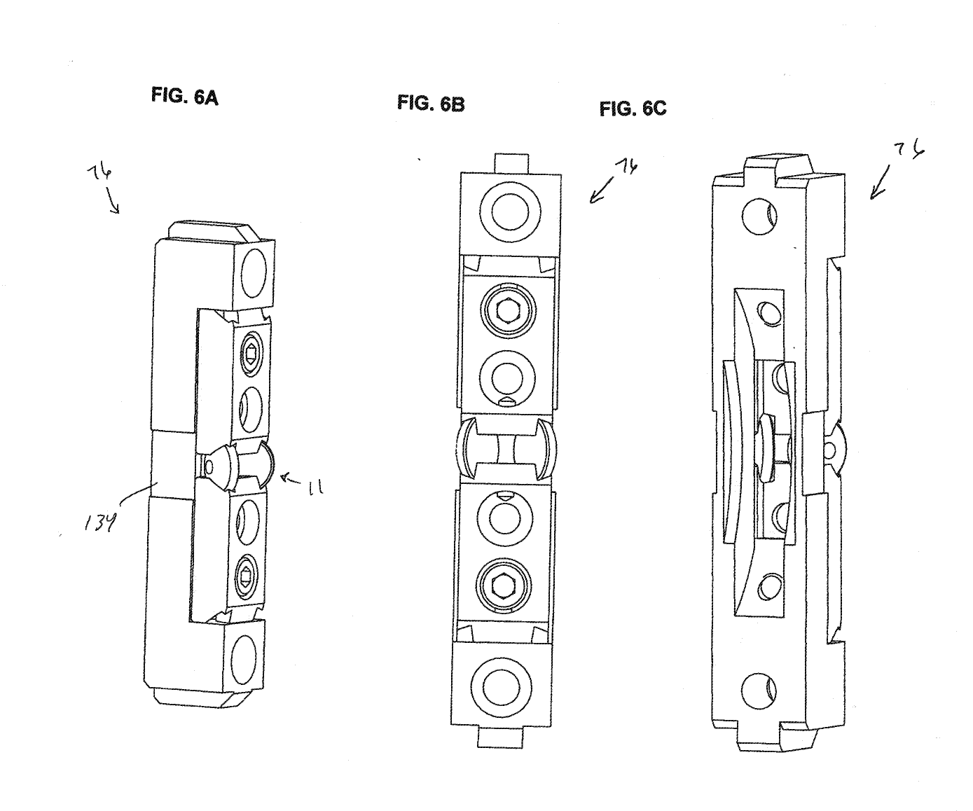

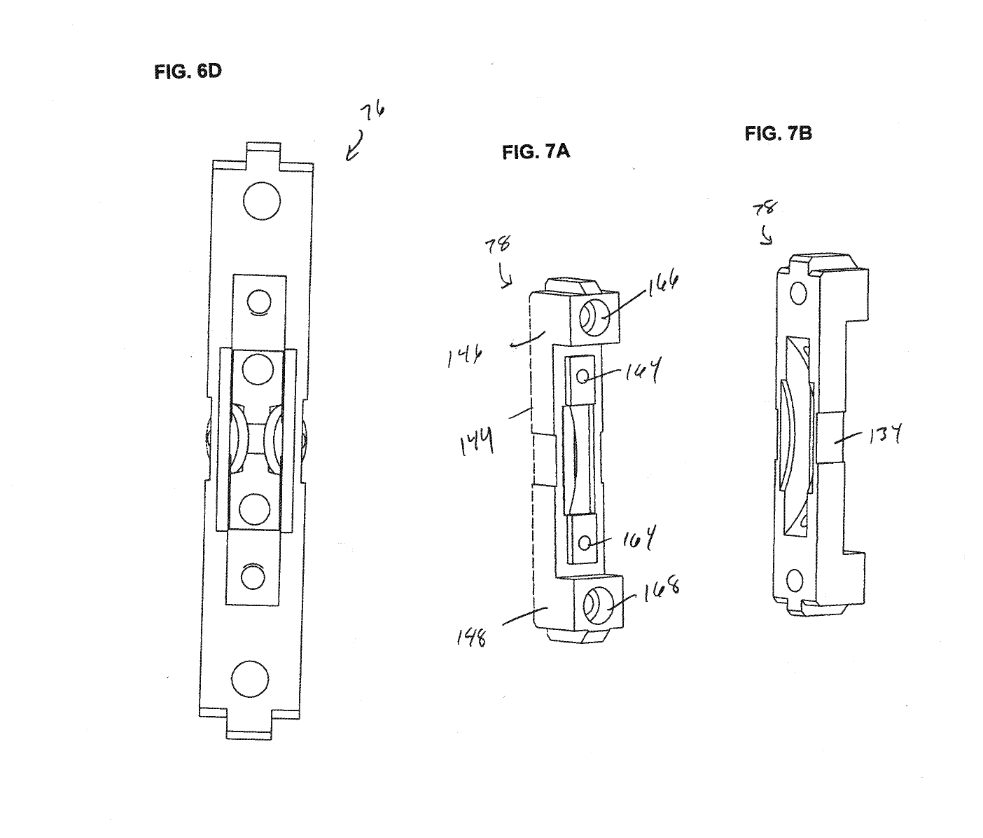

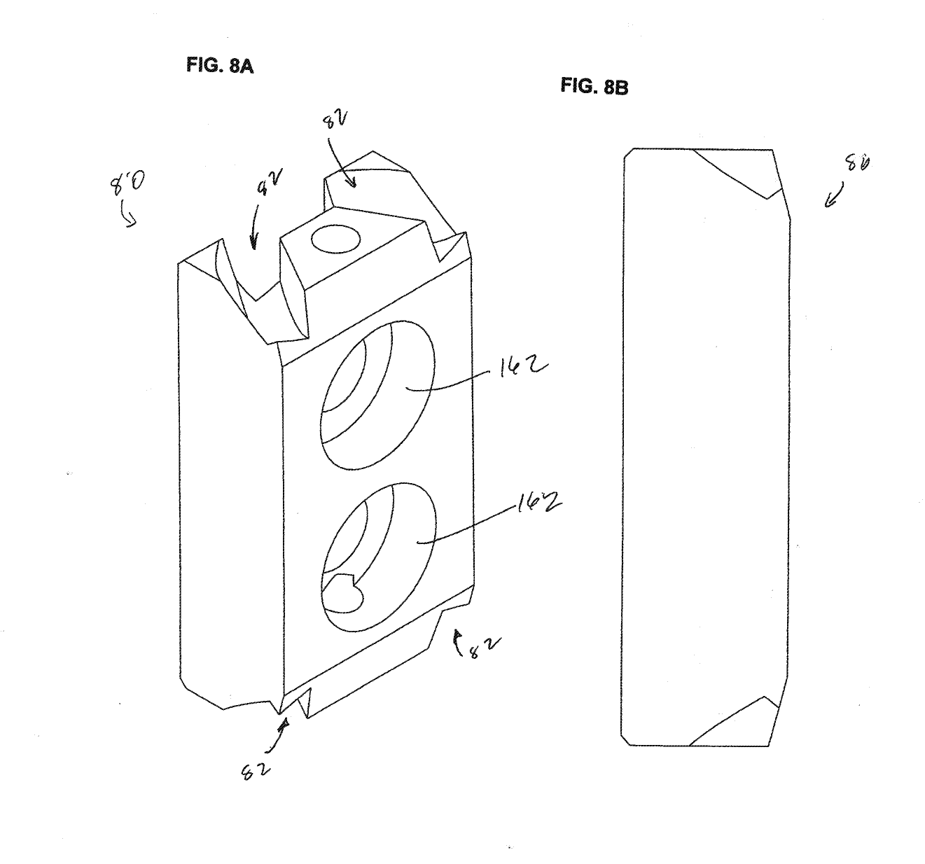

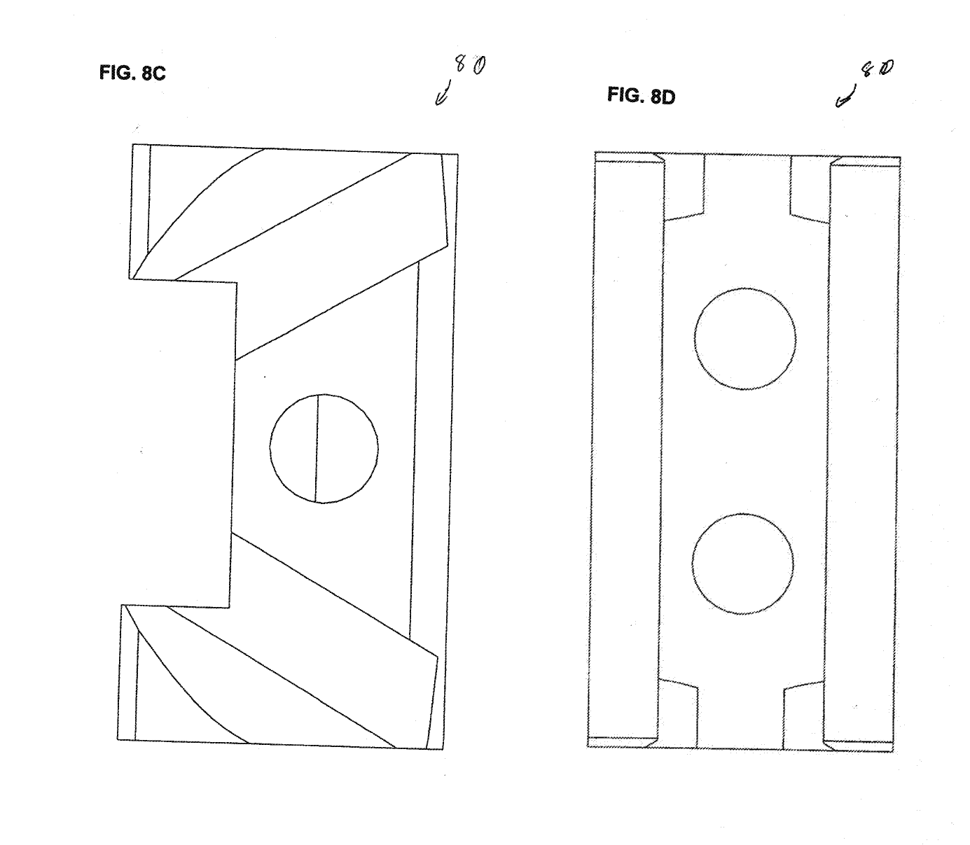

Referring to FIGS. 1B, the pair of work rollers 11 project forwardly from the front side of the rolling tool assembly 10. The work rollers 11 are rotatably mounted to the rolling tool assembly 10 so as to be able to be engaged with high forces against the undercut fillet areas 72 adjacent to the fences or side walls 74 on either side of the pin bearing 12. For this purpose, the pair of work rollers 11 are mounted to extend to be canted outwardly away from one another at the forward side of the rolling tool assembly 10. To be able to easily change out the work rollers 11 when they become worn, they are carried in a work roller cartridge 76 that is removably secured to the front side of the housing assembly 14. The work rollers 11 are premounted to the cartridge 76 so that when the work rollers 11 become worn, a different cartridge 76 having unworn work rollers 11 can be interchanged with cartridge 76 having the worn work rollers 11 without having to individually handle the rollers 11 for removal and replacement thereof. The cartridge 76 is shown in FIGS. 6A-6D. Each cartridge 76 includes a holder member 78 (FIGS. 7A and 7B) to which are secured a pair of identical cage members 80 (FIGS. 8A-8D). The cage members 80 each include a pair of roller pockets 82 at either end thereof to be reversible, as will be described in more detail hereinafter. With the assembled cartridge 76 secured to the front side of the housing assembly 14, the work rollers 11 will project outwardly at an inclined angle away from each other for being received in the undercut fillet areas 72 of the crankshaft bearing 12. As is apparent, as the axial width of the crankshaft bearing changes in size, the cartridge 76 including the cage members 80 will change in size so that the pockets 82 thereof having the work rollers 11 received therein are properly positioned for orienting the rollers 11 to be received in the fillet areas of the crankshaft bearing.

For example, comparing rolling assemblies 10 and 22, it can be seen that for the narrower crankshaft bearing 12, a relatively narrow cartridge 76 in the lateral direction is provided so that the work rollers 11 are positioned relatively close together, as can be best seen in FIG. 1C. On the other hand, for wider or axially longer crankshaft bearings such as crankshaft bearing 28, a laterally wider cartridge 76 is provided so that the work rollers 11 are spaced further apart from each other, as can be best seen in FIG. 9B.

In addition, as previously discussed while the dimensions of the main body members 16 stay the same in the rolling tool assemblies 10 and 22, the side plate member 18, 20 and 26 are different in their dimensions to accommodate the different size bearings they are adapted to roll. Referencing Example 1 and FIGS. 1A and 9A, it can be seen that the plate members 18, 20 and 26 have a different fore-and-aft offset distance between the center of the respective spindles 84 and 86 for their back-up rollers 88 and 90 and the front side 92 and 94 of the plate members 18, 20 and 26, respectively. As shown, the offset distance X₁ for the plate members 18, 20 is smaller than the offset distance X₂ for the plate members 26 such that the spindle opening 96 for the plate member 26 is spaced further rearwardly from the plate front side 94 than the spacing of the spindle opening 98 from the front side 92 of the plate member 18, 20.

The reason for this difference in the offsets X₁ and X₂ is that with the smaller diameter crankshaft bearings such as crankshaft bearing 12, the work rollers 11 need to project further forwardly to engage in the fillet areas 72 of the smaller crankshaft bearing 12. By positioning the back-up roller 88 so that its center is closer to the front side 92 of the plate members 18, 20, the back-up roller 88 will project further forwardly beyond the plate front side 92 for supporting the work rollers 11 for receipt in the fillet areas 72 of the smaller diameter crankshaft bearing 12. On the other hand, with the larger diameter crankshaft bearing such as crankshaft bearing 28, the larger offset distance X₂ causes the back-up roller 90 to project beyond the front side 94 of the plate members 26 but at a distance that is closer thereto so that the work rollers 11 are properly received in the fillet areas 100 of the crankshaft bearing 28 adjacent the side walls or fences 102 thereof.

The generally C-shaped body member 16 will next be described. The body member 16 includes an upper leg portion 104 and a lower leg portion 106 that extend generally parallel to each other and forwardly from a rear wall portion 108 that extends generally orthogonal to and interconnects the upper and lower leg portions 104 and 106. An interior, central flange or web portion 110 extends along the inner sides of the upper and lower leg portions 104 and 106 and the rear wall portion and has an arcuate or C-shaped interior surface 112 facing forwardly therealong. The flange portion 110 serves as a mounting member for the side plate members 18, 20 and the work roller cartridge 76. More particularly, the flange includes fastener through openings 114 for being aligned with corresponding through openings 116 in the side plate members 18, 20. When the through openings 114 and 116 are aligned, fasteners 118 can be received therethrough to secure the side plate members 18, 20 to the body member 16 to form the housing assembly 14. The three-piece housing assemblies for the other work roller rolling tool assemblies described herein are formed in a similar manner.

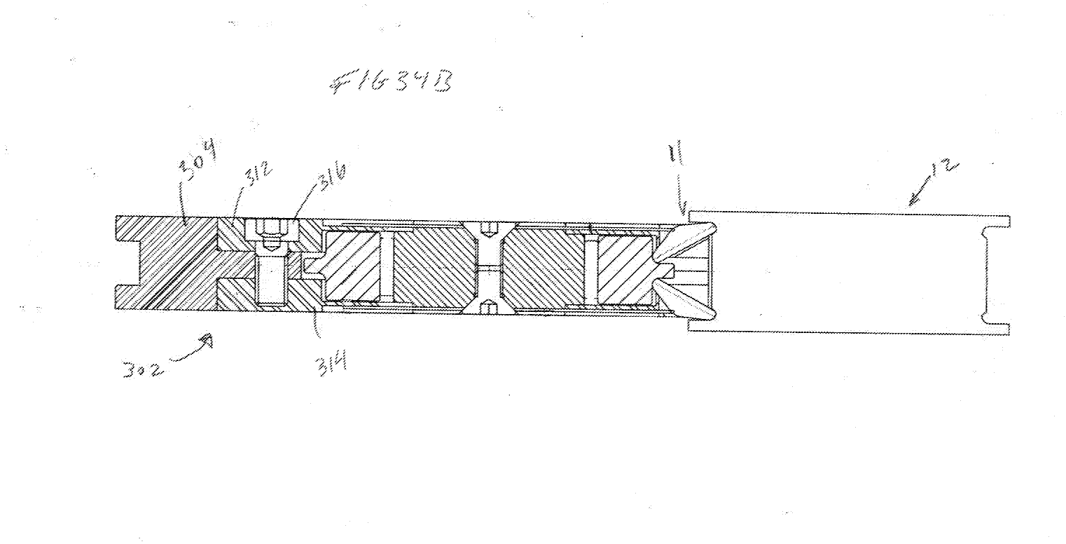

An alternative rolling tool assembly 300 carrying work rollers 11 is shown in FIGS. 34A and 34B. As can be seen, housing assembly 302 has the same three-piece housing construction as previously described. The main difference is that generally C-shaped body member 304 has upper and lower leg portions 304 and 306 that extend forwardly from rear wall portion 308 and which have arcuate inner surfaces that together cooperate to form a generally annular opening 310 through the body member 304 for receiving annular side plate members 312 and 314 secured thereto at either side thereof.

The annular side plate member 312 is secured to the one side of the body member 304 by fasteners 316 spaced circumferentially thereabout. The annular side plate member 314 is provided with the circumferentially spaced key hole slots 318 corresponding to the fasteners 316. For securing the annular plate member 314 to the body member 304, the narrow portion of each of the slots 318 is aligned with the corresponding fasteners 316 to be received therein. For accessing the interior of the body member 304, an operator need only loosen the fasteners 316 and twist either one or both of the annular side plate members 312 and 314 to generate relative rotation therebetween so that the distal ends of the fasteners 316 are circumferentially shifted to the wide portions of the slots 318 allowing the plate member 314 to be removed from the housing assembly 302.

Next, the plate members 18, 20 will be described in more detail. The plate members 18, 20 have an interior surface 120 with a D-shaped recess 122 formed therein, as best seen in FIGS. 3B and 4B. When the side plate members 18, 20 are fastened to the body member 16, the interior surfaces 120 will engage either side of the body member flange portion 110 with the D-shaped recesses 122 cooperating with the C-shaped surface 112 of the flange portion 110 to form a generally annular interior space in which the back-up roller 88 is rotatably mounted in the housing assembly 14 of the rolling tool assembly 10.

The plate member 18, 20 has an exterior surface 124 and is provided with a lateral thickness between the interior surface 120 and the exterior surface 124 such that when the plate members 18, 20 are fastened to either side of the base member flange portion 110, the exterior surfaces 124 of the opposed plate members 18, 20 will be substantially flush with the adjacent exterior side surfaces 126 and 128 of the generally C-shaped body member 16. The exterior surface 124 of the side plate member 18, 20 includes an elongate slot recess 130 that extends fore-and-aft to open to the front side 92 in alignment with the spindle opening 98. The recess 130 is configured to receive an elongate spring strip member 132 therein. The cartridge 76, and specifically the holder member 78 thereof has an intermediate slot recess 134 that is aligned with the elongate slot recess 130 for receiving the forward portion of the spring strip member 132 to extend therein so that a reduced end extension 136 of the spring strip member 132 is engaged with the back side of the corresponding work roller 11 for urging it forwardly in the pockets 82 of the cage members 80 in which it is captured.

On the other hand, for the wider or axially longer crankshaft bearing 28, the plate members 26 are laterally thicker between their interior surface 138 and exterior surface 140 than the plate members 16, 18. In other respects, construction of the side plate members 26 is the same of that of the side plate members 18, 20 and thus will not be repeated herein. Accordingly, with the thicker side plate members 26 fastened to the opposite sides of the flange portion 110, the exterior surfaces 140 will be offset from and laterally beyond the corresponding exterior surfaces 126 and 128 of the main body member 16, as can be seen in FIG. 9C. In this manner, when the spring strip member 132 is disposed in the elongate slot recess 142, the reduced end extension 136 will be in proper alignment for engaging the corresponding work roller 11 in the pockets 82 of the wider cage members 80 of the wider cartridge 76 used when rolling the crankshaft bearing 28, as previously discussed.

Another adaptation relating to the different sizes of cartridges 76 is that for the larger crankshaft bearing 28, the cartridge 76 is provided with a decreased fore-and-aft thickness to position the work rollers 11 closer to the front side 94 of the plate members 26. In this regard, the holder member 78 has an elongate rear wall portion 144 having enlarged upper and lower mounting block portions 146 and 148 at either end thereof. As can be seen in FIG. 9A, the rear wall portion 144 is thinner in the fore-and-aft direction in the cartridge 76 used with the rolling tool assembly 22 than the rear wall portion 144 used with the rolling tool assembly 10 used in the rolling tool assembly 10 shown in FIG. 1A. Thus, referring to FIGS. 1A and 1B, it can be seen that the cartridge 76 of the rolling tool assembly 10 projects forwardly beyond the forward ends of the upper and lower leg portions 104 and 106 of the body member 16 for proper positioning of the work rollers 11 in the fillet areas 72 of the smaller crankshaft bearing 12. On the other hand, referring to FIG. 9A, it can be seen that the cartridge 76 of the rolling tool assembly 22 is substantially flush with the forward ends of the upper and lower leg portions 104 and 106 of the body member 16 for the proper positioning of the work rollers 11 in the fillet areas 100 of he larger crankshaft bearing 28.

Turning next to the rolling tool assemblies 30 and 38 of FIGS. 12 and 15, respectively, these tools 30 and 38 take the other approach where the side plate members 36 are common to each of the tools 30 and 38 and thus are standard for the different size crankshaft bearings 12 and 28 that these tools are adapted to roll. Instead, it is the generally C-shaped body members 34 and 42 thereof that vary in certain predetermined dimensions thereof. Accordingly, to orient their back-up rollers 150 and 152 to project beyond the forward sides of the respective housing assemblies 32 and 40 by an appropriate amount, the thicknesses of the rear wall portion 154 and 156 of the body members 34 and 42 in the fore-and-aft direction are different. More specifically, referring to FIGS. 12 and 15 and Example 2, it can be seen that the rolling tool assembly 30 has a thicker rear wall portion 154 in the fore-and-aft direction than does the rolling tool assembly 38 which has a thinner rear wall portion 156. In this manner, the back up roller 150 is oriented more forwardly in its housing assembly 32 than the back-up roller 152 is in its housing assembly 40, and thus projects beyond the forward side of the housing assembly 32 by a greater amount than the back-up roller 152 projects beyond the forward side of the housing assembly 40 in which it is rotatably mounted.

Further, it is can be seen that the lateral thicknesses of the C-shaped body members 34 and 42 are different to generally correspond to that of the lateral widths of the cartridges 76 used with the rolling tool assemblies 30 and 38 so that they are adapted to roll the narrow crankshaft bearing 12 and the wide crankshaft bearing 28, respectively, as has previously been described. In this regard, the body member 34 has a narrow interior flange portion 158 and the body 42 has a laterally wider interior flange portion 160 so that when the same side plate members 36 are fastened thereto, the exterior surfaces of the side plate member 36 are flush with the adjacent exterior side surfaces of the C-shaped body members 34 and 38 for proper positioning of the spring strip members 132 in alignment with the work rollers 11.

As previously mentioned, the cage members 80 have a pair of work roller pockets 82 at either end thereof. A pair of cage members 80 are fastened to the holder member 78, and more particularly to the rear wall portion 144 between the mounting block portions 146 and 148 at either end thereof. Thus, each work roller 11 is received in a pair of pockets 82, which includes one of the pockets 82 of the upper cage member 80 and one of the pockets 82 of the lower cage member 80. When the surfaces of the pockets 82 become worn, the cage members 80 can simply be reversed or turned so that the pockets 82 at the other end are now in position for receiving the work rollers 11 therein. For this purpose, each cage member 80 includes a pair of through openings 162, and the holder member 78 includes a pair of apertures 164. Each cage member 80 is mounted to the holder member 78 so that one or the other of the though openings 162 is aligned with a corresponding one of the apertures 164 for receiving a fastener 165 therein. Reversing the cage member requires that the other one of the through openings 162 be aligned with the holder aperture 164 with the fastener 165 then received therein.

To mount the cartridge 76 to the housing assembly 14, for example, the holder mounting block portions 146 and 148 have through openings 166 and 168, and the body member flange portion 110 has corresponding upper and lower forwardly facing apertures 170 and 172. The cartridge 76 is oriented so that the through openings 166 and 168 are aligned with the corresponding apertures 170 and 172 for receiving fasteners 174 therein. Thus, to replace a cartridge 76, such as when the work rollers 11 carried thereby are worn, an operator only needs to remove the fasteners 174 to remove the cartridge 76 whereupon another cartridge 76 having unworn rollers 11 can be fastened to the housing assembly 14 as described above. No longer need the operator individually remove the prior cage members and handle the work rollers for replacement thereof.

Next, different rolling tool assemblies for support rollers 45 will be described. As is known, the support rollers 45 engage the crankshaft bearing while the work rollers 11 are engaged in the fillet areas at either axial side of the bearing during a crankshaft rolling operation. As previously described, support roller rolling tool assemblies 44 and 58 are specifically adapted for rolling the smaller crankshaft bearing 12, and thus would be used in a crankshaft rolling machine in conjunction with either the work roller rolling tool assembly 10 or 30 while the support roller rolling tool assemblies 54 and 66 are adapted to roll the larger crankshaft bearing 28 and thus would be used in a crankshaft rolling tool machine in conjunction with either the work roller rolling tool assembly 22 or 38.

As previously discussed, the rolling tool assemblies 44 and 54 have a standard main body member 48 used for their respective housing assemblies 46 and 56 despite being adapted to roll different sizes of crankshaft bearings 12 and 28, respectively. However, their side plate members 50, 52 and 57 are different.

Referring to FIGS. 18F and 24B, it can be seen that the support rollers 45 used in the rolling tool assembly 44 for rolling the smaller crankshaft bearing 12 are laterally narrower than the support rollers 45 used in the rolling tool assembly 54 for rolling the larger crankshaft bearing 28. For accommodating the different width support rollers 45, the side plate member 50, 52 is provided with a lateral thickness between its exterior surface 176 and interior surface 178 that is thinner than the lateral thickness of the side plate member 57 between its exterior surface 180 and its interior surface 182. This difference in lateral thickness is such that generally annular recesses 184 (FIGS. 20B and 21B) formed in the interior surface 178 of the side plate member 50, 52 for the support rollers 45 are shallower than the deeper generally annular recesses 186 (FIG. 26B) formed in the interior surface 182 of the side plate member 57. In this manner, the side plate members 50 and 52 when secured to the body member 48 are adapted to receive the narrower support rollers 45 in clearance therebetween in the shallower recesses 184 thereof, and the side plate members 57 secured to the body member 48 are adapted to receive the wider support rollers 45 in clearance therebetween in the deeper recesses 186 thereof.

The main body member 48 has a similar C-shaped construction to the previously described body members including upper and lower leg generally parallel leg portions 188 and 190 that are interconnected by and extend forwardly from either end of an elongate rear wall portion 192 extending therebetween. Rather than a single continuous flange portion, the main body member 48 has an upper flange portion 194 that extends along the upper leg portion 188 and down along the rear wall portion 192 terminating slightly before reaching the midpoint of the length of the rear wall portion 192. Likewise, a lower flange portion 196 extends along the lower leg portion 190 and up along the rear wall portion 192 terminating just short of the midpoint thereof so that there is gap 198 between the facing ends of the upper and lower flange portions 194 and 196. The upper flange portion 194 includes an arcuate or generally C-shaped interior surface 200 that generally faces forwardly and downwardly, and the lower flange portion 196 has an arcuate or generally C-shaped interior surface 202 that generally faces forwardly and upwardly. Thus, when the side plate members 50 and 52 are fastened to either side of the flange portions 194 and 196, the side plate recesses 184 cooperate with flange portion arcuate surfaces 200 and 202 to form generally annular interior spaces sized for receipt of the smaller width support rollers 44 therein. Similarly, when the side plate members 57 are fastened to either side of the upper and lower flange portions 194 and 196, the side plate recesses 186 cooperate with the flange portion arcuate surfaces 200 and 202 to form generally annular interior spaces in the housing assembly 60 sized for receipt of the larger width support rollers 45 therein.

Referring next to the rolling tool assemblies 58 and 66, these tools have a standard side plate 64 used for their respective housing assemblies 60 and 68 despite being adapted to roll different sizes of crankshaft bearings 12 and 28, respectively. However, their main body members 62 and 70 are different. More particularly, the main body member 62 is provided with a lateral thickness that is thinner than the lateral thickness of main body member 70, as can be seen comparing the body member 62 shown in FIGS. 28A and 28B and the body member 70 shown in FIGS. 31A and 31B.

In this manner, flange portions 204 and 206 of the body member 62 are laterally narrow so that their corresponding interior curved surfaces 208 and 210 are similarly laterally narrow for cooperating with generally annular recesses of the side plate members 64 when the side plate members 64 are secured to either side of the flange portions 204 and 206 to form appropriately sized narrow annular interior spaces in the housing assembly 60 for the laterally narrow support rollers 45 adapted to engage the smaller crankshaft bearing 12. Likewise, the laterally wider body member 70 has flange portions 212 and 214 that are wider than the corresponding flange portions 204 and 206 of the body member 62 so that their respective interior curved surfaces 216 and 218 are likewise laterally wider than the corresponding interior surfaces 208 and 210 of the flange portions 204 and 206. Thus, when the plate members 64 are secured to either side of the flange portions 212 and 214, the plate member annular recesses will cooperate with the interior surfaces 216 and 218 to form appropriately sized wide annular interior spaces in the housing assembly 68 for receiving the laterally wider support rollers 45 adapted to engage the larger crankshaft bearing 28.

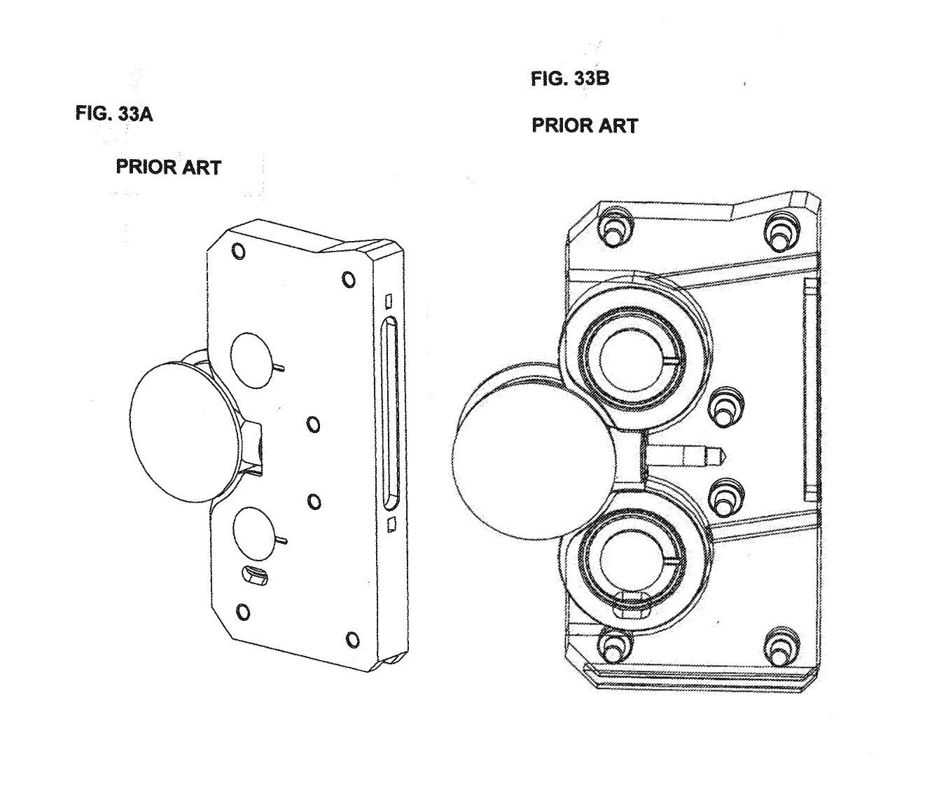

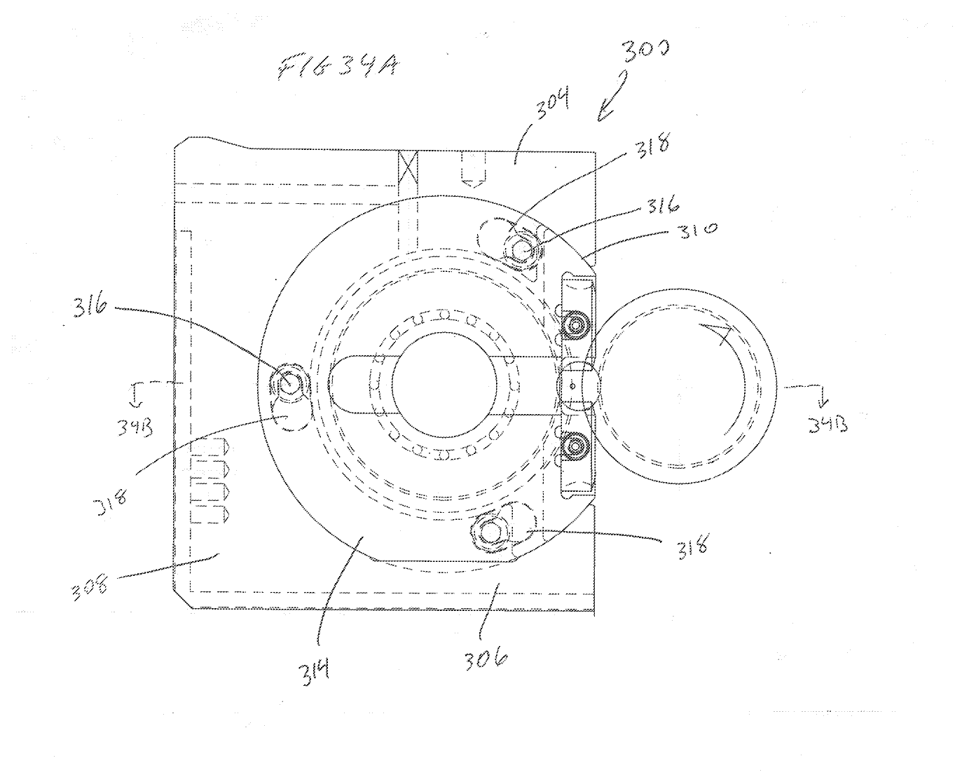

Another adaptation for the support roller tool assemblies described herein is the use of a modular cam follower cartridge 220 for ease of changing to different cam followers such as in the form of the illustrated cam rollers 222. In the prior support roller rolling tool assembly shown in FIGS. 33A and 33B, the cam roller has its axle shaft threaded directly to the body member of the two-part housing assembly. As has been previously described, this made it extremely difficult to remove the cam roller 222 for replacement thereof such as when worn because the drive recess of the threaded shoulder bolt acting as the axle shaft often became filled with metallic debris that could not be easily dislodged therefrom.

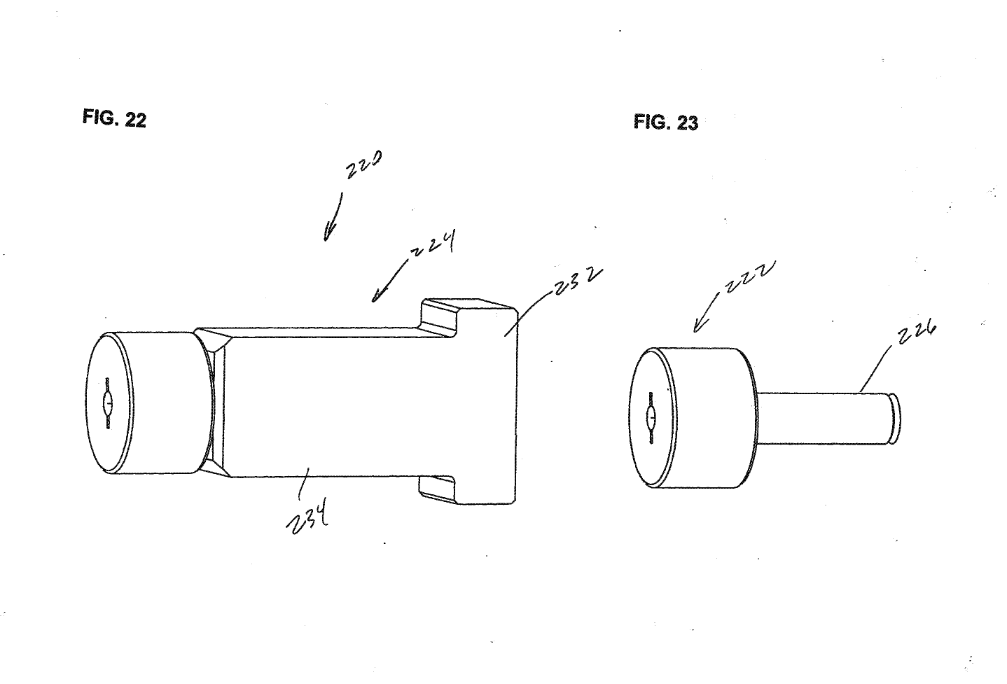

By contrast, the cam follower cartridge 220 as shown in FIG. 22 includes a guide mounting block 224 that can have a T-shaped configuration for being captured in the previously described housing assemblies for the support rollers 45. The guide mounting block 224 has a threaded bore into which threaded shaft 226 is received. The shaft 226 also has a non-threaded portion about which the roller 222 is rotatable to act as an axle therefore.

As previously discussed, the flange portions 194 and 196 of the body member 48 of housing assembly 46 have a gap 198 between their facing ends. This structure is common to each of the body members for the above-described support roller rolling tool assemblies. The gap 198 has an enlarged rear portion 228 and a narrower forwardly extending portion 230, as can be seen in FIGS. 19A-19C. The T-shaped mounting block 224 has an enlarged rear portion 232 and a narrower forwardly extending portion 234 that are sized for being received in the corresponding portions 228 and 230 of the gap 198, as can be seen in FIGS. 18C and 18D. In this regard, it can be seen that the block forward portion 234 is sized to extend through the narrow gap portion 230 and forwardly therefrom so that the cam roller 222 is disposed between the support rollers 45 thereabove and therebelow, as well as between the side fences or walls on either side of the crankshaft bearing that is being roller.

The side plate members 50, 52 can include a guide slot recess 236 generally intermediate the upper and lower arcuate annular recesses 184 and which extends forwardly to a cutout 238 that is between the annular recesses 184 thereabove and therebelow. When the side plates 50 and 52 are fastened to either side of the flange portions 194 and 196, the slot recesses 236 will be aligned with the gap 198 so that the cutout 238 will be aligned with the position of the cam roller 222 when received in the housing assembly 46, as can be seen in FIG. 18E. Further, each of the side plate members 50, 52 includes inclined edges 240 that extend forwardly from the cutout 238 and taper away from each other to the front side of the plate members 50, 52 so that the support rollers 45 are exposed beyond the edges 240 for engaging the crankshaft bearing. Again, this structure is common to each of the side plate members for the above-described support roller rolling tool assemblies.

Thus, for removing the cam roller 222 from the support roller rolling tool assembly, an operator only need to remove one of the side plate members 50, 52 to provide access to the cam follower cartridge 220 which then can be laterally slid out of the open sided housing assembly 46 for replacement with a different cam follower cartridge 220 having a new cam roller 222. In this manner, the cam follower cartridge 220 herein avoids the need for unscrewing the fastener for the cam roller for replacement thereof as required with the prior support roller rolling tool assembly shown in FIGS. 33A and 33B. In addition, the replacement cartridge 220 can have different sizes of cam rollers 222 so that, for example, a differently sized cam roller than the one being replaced can be selected to be mounted to the rolling tool assembly if desired for a particular bearing to be rolled.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A rolling tool assembly for rolling crankshaft bearings, the rolling tool assembly comprising:
a housing;
at least one roller mounted to the housing;
a main C-shaped body member of the housing having open sides; and
a pair of opposing side plate members configured to be secured to the C-shaped body member to close the open sides thereof so that the housing has a three-piece construction.

2. The rolling tool assembly of claim 1 wherein one of the C-shaped body member and the pair of side plate members remains the same to be of standardized size for rolling different size crankshaft bearings while the other of the C-shaped body member and the pair of side plate members varies in dimensions to be customized in size depending on size of the crankshaft bearing to be rolled.
